(19) United States
(12) Patent Application Publication
(10) Pub. No.: US 2020/0233321 A1
(43) Pub. Date: Jul. 23, 2020

(54) ELECTROPHOTOGRAPHIC PHOTOSENSITIVE MEMBER

(71) Applicant: KYOCERA Document Solutions Inc., Osaka (JP)

(72) Inventors: Kazutaka SUGIMOTO, Osaka-shi (JP); Kensuke OKAWA, Osaka-shi (JP); Jun AZUMA, Osaka-shi (JP)

(73) Assignee: KYOCERA Document Solutions Inc., Osaka (JP)

(21) Appl. No.: 16/746,274

(22) Filed: Jan. 17, 2020

(30) Foreign Application Priority Data
Jan. 21, 2019 (JP) 2019-007951

(51) Int. Cl. G03G 5/047; G03G 5/05

(52) U.S. Cl. CPC G03G 5/047; G03G 5/0539; G03G 5/0546

(57) ABSTRACT

An electrophotographic photosensitive member includes a conductive substrate, a charge generating layer, and a charge transport layer. The charge generating layer has a thickness of at least 0.07 μm. The charge transport layer contains a binder resin, a hole transport material, and meta-terphenyl. The binder resin includes a polyarylate resin including repeating units and a group represented by respective general formulas (1) to (3). The electrophotographic photosensitive member satisfies at least two conditions of: (A) the charge generating layer has a thickness of at least 0.12 μm; (B) the charge transport layer contains a specific amount of fluororesin particles; and (C) the charge transport layer contains meta-terphenyl in an amount of at least 5.0 parts by mass and no greater than 15.0 parts by mass relative to 100 parts by mass of the binder resin.

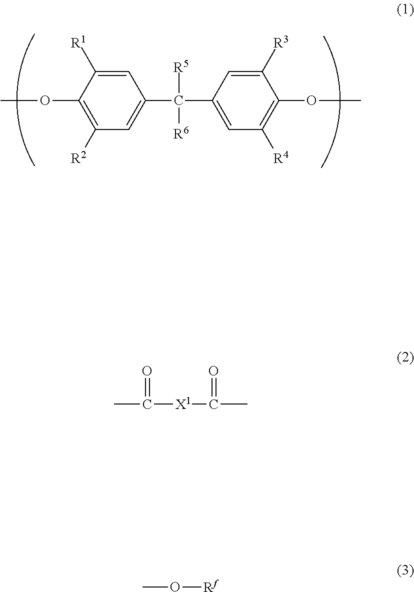

### INCORPORATION BY REFERENCE

The present application claims priority under 35 U.S.C. § 119 to Japanese Patent Application No. 2019-7951, filed on Jan. 21, 2019. The contents of this application are incorporated herein by reference in their entirety.

### BACKGROUND

The present disclosure relates to an electrophotographic photosensitive member.

Electrophotographic photosensitive members are used in electrographic image forming apparatuses. Examples of the electrophotographic photosensitive members include a multi-layer electrophotographic photosensitive member and a single-layer electrophotographic photosensitive member. The multi-layer electrophotographic photosensitive member includes photosensitive layers including a charge generating layer having a charge generating function and a charge transport layer having a charge transporting function. The single-layer electrophotographic photosensitive member includes a single-layer photosensitive layer having a charge generating function and a charge transporting function.

A multi-layer electrophotographic photosensitive member including a charge transport layer containing a polyarylate resin has been studied as an example of the electrophotographic photosensitive members.

### SUMMARY

An electrophotographic photosensitive member according to an embodiment of the present disclosure includes a conductive substrate and a photosensitive layer disposed either directly or indirectly on the conductive substrate. The photosensitive layer includes a charge generating layer and a charge transport layer disposed in stated order from a side of the conductive substrate. The charge generating layer has a thickness of at least 0.07 μm. The charge transport layer contains a binder resin, a hole transport material, and meta-terphenyl. The binder resin includes a polyarylate resin including a first repeating unit represented by a general formula (1) shown below, a second repeating unit represented by a general formula (2) shown below, and a terminal group represented by a general formula (3) shown below. The electrophotographic photosensitive member according to the aspect of the present disclosure satisfies at least two of the following conditions (A) to (C).

(A) The charge generating layer has a thickness of at least 0.12 μm.
(B) The charge transport layer contains fluororesin particles in an amount of at least 1.5 parts by mass and no greater than 11.0 parts by mass relative to 100 parts by mass of the binder resin.
(C) The charge transport layer contains the meta-terphenyl in an amount of at least 5.0 parts by mass and no greater than 15.0 parts by mass relative to 100 parts by mass of the binder resin.

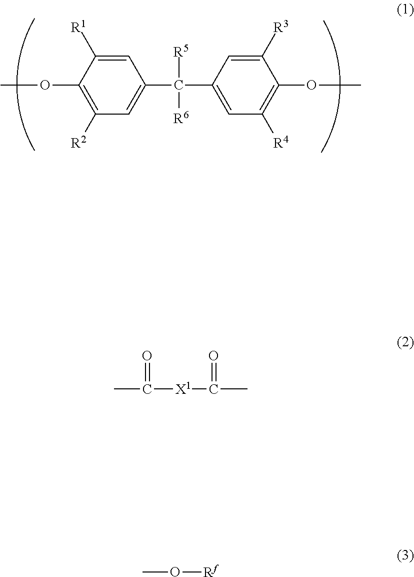

In the general formula (1), R¹, R², R³, and R⁴ each represent, independently of one another, a hydrogen atom or a methyl group. R⁵ and R⁶ each represent, independently of one another, a hydrogen atom or an alkyl group having a carbon number of at least 1 and no greater than 4. R⁵ and R⁶ may be bonded to each other to form a divalent group represented by general formula (X) shown below. In the general formula (2), X¹ represents a divalent group represented by chemical formula (2A), (2B), (2C), or (2D) shown below. In the general formula (3), R^{f} represents a chain aliphatic group having a carbon number of at least 1 and no greater than 20 and substituted with at least one fluorine atom.

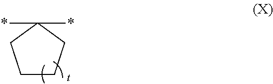

In the general formula (X), t represents an integer of at least 1 and no greater than 3. In the general formula (X), * represents a bond.

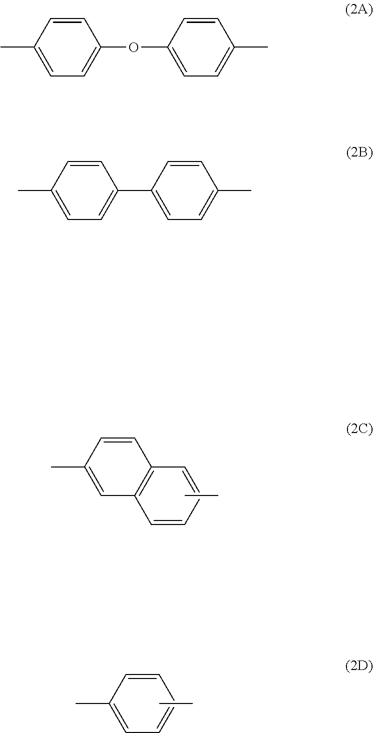

### BRIEF DESCRIPTION OF THE DRAWINGS

FIG. 1 is a cross-sectional view of an example of an electrophotographic photosensitive member according to an embodiment of the present disclosure.

FIG. 2 is a cross-sectional view of an example of the electrophotographic photosensitive member according to the embodiment of the present disclosure.

### DETAILED DESCRIPTION

The following describes an embodiment of the present disclosure in detail. However, the present disclosure is by no means limited to the following embodiment. The present disclosure can be practiced within a scope of objects of the present disclosure with alterations made as appropriate. Although some overlapping explanations may be omitted as appropriate, such omission does not limit the gist of the present disclosure.

In the following description, the term “-based” may be appended to the name of a chemical compound to form a generic name encompassing both the chemical compound itself and derivatives thereof.

In the following description, a halogen atom, an alkyl group having a carbon number of at least 1 and no greater than 8, an alkyl group having a carbon number of at least 1 and no greater than 6, an alkyl group having a carbon number of at least 1 and no greater than 4, an alkyl group having a carbon number of at least 3 and no greater than 5, an alkoxy group having a carbon number of at least 1 and no greater than 8, an alkoxy group having a carbon number of at least 1 and no greater than 4, and a cycloalkane having a carbon number of at least 5 and no greater than 7 mean the following unless otherwise stated.

Examples of the halogen atom (halogen group) include a fluorine atom, (fluoro group), a chlorine atom (chloro group), a bromine atom (bromo group), and an iodine atom (iodo group).

An alkyl group having a carbon number of at least 1 and no greater than 8, an alkyl group having a carbon number of at least 1 and no greater than 6, an alkyl group having a carbon number of at least 1 and no greater than 4, and an alkyl group having a carbon number of at least 3 and no greater than 5 as used herein each refer to an unsubstituted straight chain or branched chain alkyl group. Examples of the alkyl group having a carbon number of at least 1 and no greater than 8 include a methyl group, an ethyl group, an n-propyl group, an isopropyl group, an n-butyl group, a sec-butyl group, a tert-butyl group, an n-pentyl group, an isopentyl group, a neopentyl group, a 1,2-dimethylpropyl group, a straight chain or branched chain hexyl group, a straight chain or branched chain heptyl group, and a straight chain or branched chain octyl group. Examples of the alkyl group having a carbon number of at least 1 and no greater than 6, the alkyl group having a carbon number of at least 1 and no greater than 4, and the alkyl group having a carbon number of at least 3 and no greater than 5 are respectively groups having a carbon number of at least 1 and no greater than 6, groups having a carbon number of at least 1 and no greater than 4, and groups having a carbon number of at least 3 and no greater than 5 among the above-listed examples of the alkoxy groups having a carbon number of at least 1 and no greater than 8.

An alkoxy group having a carbon number of at least 1 and no greater than 8 and an alkoxy groups having a carbon number of at least 1 and no greater than 4 as used herein each refer to an unsubstituted straight chain or branched chain alkoxy group. Examples of the alkoxy group having a carbon number of at least 1 and no greater than 8 include a methoxy group, an ethoxy group, an n-propoxy group, an isopropoxy group, an n-butoxy group, a sec-butoxy group, a tert-butoxy group, an n-pentoxy group, an isopentoxy group, a neopentoxy group, a straight chain or branched chain hexyloxy group, a straight chain or branched chain heptyloxy group, and a straight chain or branched chain octyloxy group. Examples of the alkoxy group having a carbon number of at least 1 and no greater than 4 are groups having a carbon number of at least 1 and no greater than 4 among the above-listed examples of the alkoxy group having a carbon number of at least 1 and no greater than 8.

A cycloalkane having a carbon number of at least 5 and no greater than 7 as used herein refers to an unsubstituted cycloalkane. Examples of the cycloalkane having a carbon number of at least 5 and no greater than 7 include cyclopentane, cyclohexane, and cycloheptane.

### <Electrophotographic Photosensitive Member>

An electrophotographic photosensitive member according to an embodiment of the present disclosure (also referred to below as a photosensitive member”) includes a conductive substrate and a photosensitive layer disposed either directly or indirectly on the conductive substrate. The photosensitive layer includes a charge generating layer and a charge transport layer disposed in stated order from a side of the conductive substrate. The charge transport layer contains a binder resin, a hole transport material, and meta-terphenyl. The binder resin includes a polyarylate resin (also referred to below as a “polyarylate resin (PA)”) including a first repeating unit represented by general formula (1) shown below (also referred to below as a “repeating unit (1)”), a second repeating unit represented by g general formula (2) shown below (also referred to below as a repeating unit (2)”), and a terminal group represented by general formula (3) shown below (also referred to below as a “terminal group (3)”). The electrophotographic photosensitive member according to the embodiment of the present disclosure satisfies at least two of the following conditions (A) to (C).

(A) The charge generating layer has a thickness of at least 0.12 μm.
(B) The charge transport layer contains fluororesin particles in an amount of at least 1.5 parts by mass and no greater than 11.0 parts by mass relative to 100 parts by mass of the binder resin.
(C) The charge transport layer contains the meta-terphenyl in an amount of at least 5.0 parts by mass and no greater than 15.0 parts by mass relative to 100 parts by mass of the binder resin.

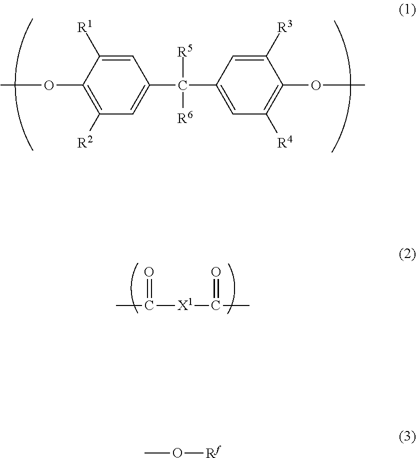

In general formula (1), R¹, R², R³, and R⁴ each represent, independently of one another, a hydrogen atom or a methyl group. R⁵ and R⁶ each represent, independently of one another, a hydrogen atom or an alkyl group having a carbon number of at least 1 and no greater than 4. R⁵ and R⁶ may be bonded to each other to form a divalent group represented by general formula (X) shown below. In general formula (2), X¹ represents a divalent group represented by chemical formula (2A), (2B), (2C), or (2D) shown below. In general formula (3), R^{f} represents a chain aliphatic group having a carbon number of at least 1 and no greater than 20 and substituted with at least one fluorine atom.

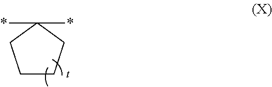

In general formula (X), t represents an integer of at least 1 and no greater than 3. In general formula (X), * represents a bond.

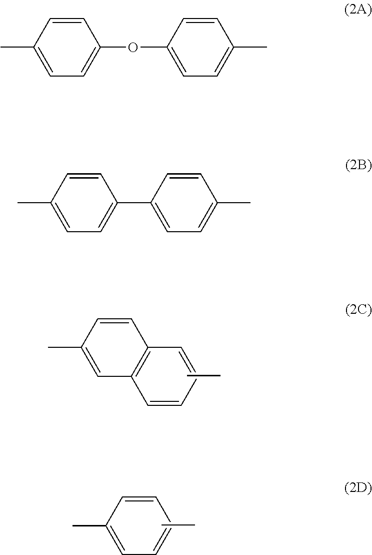

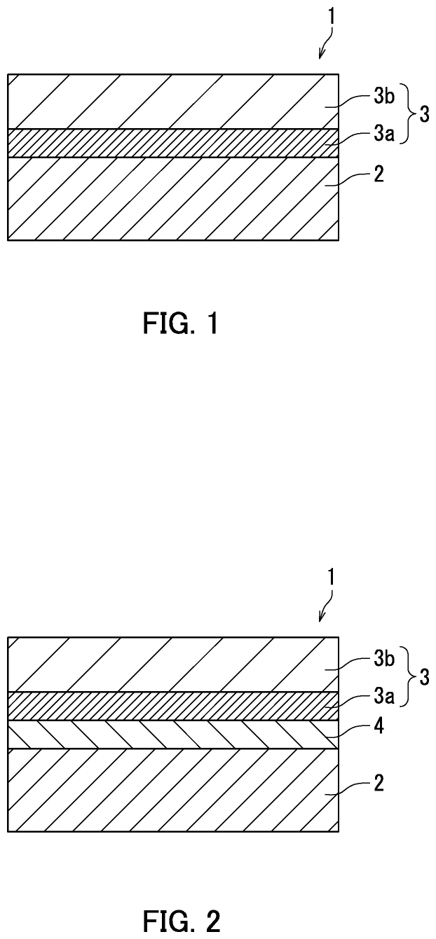

The following describes structure of the photosensitive member with reference to FIGS. 1 and 2. FIGS. 1 and 2 are cross-sectional views each illustrating an example of a photosensitive member 1 according to an embodiment of the present disclosure.

As illustrated in FIG. 1, the photosensitive member 1 is a multi-layer photosensitive member including for example a conductive substrate 2 and a photosensitive layer 3 disposed either directly or indirectly on the conductive substrate 2. The photosensitive layer 3 includes a charge generating layer 3a and a charge transport layer 3b disposed in stated order from a side of the conductive substrate 2.

As illustrated in FIG. 2, the photosensitive member 1 may be a multi-layer photosensitive member including for example the conductive substrate 2, an intermediate layer 4 (undercoat layer) disposed directly on the conductive substrate 2, and the photosensitive layer 3 disposed directly on the intermediate layer 4. That is, the photosensitive layer 3 may be disposed indirectly on the conductive substrate 2. Note that the photosensitive member 1 in each of FIGS. 1 and 2 may further include a protective layer (not illustrated) disposed on the photosensitive layer 3.

The charge generating layer 3a has a thickness of at least 0.07 μm, preferably has a thickness of at least 0.12 μm, and more preferably has a thickness of at least 0.20 μm. The charge generating layer 3a has a thickness of no greater than 5.00 μm, preferably has a thickness of no greater than 1.00 μm, and more preferably has a thickness of no greater than 0.40 μm. As a result of the charge generating layer 3a having a thickness of at least 0.07 μm, band generation caused due to high humidity can be inhibited. As a result of the charge generating layer 3a having a thickness of no greater than 5.00 μm, manufacturing cost can be reduced.

Although no particular limitations are placed on thickness of the charge transport layer 3b, the charge transport layer 3b preferably has a thickness of at least 2 μm and no greater than 100 μm, and more preferably has a thickness of at least 5 μm and no greater than 50 μm.

In terms of increasing abrasion resistance of the photosensitive member 1 and inhibition of band generation caused due to high humidity, the charge transport layer 3b is preferably disposed as an outermost layer of the photosensitive member 1. That is, the photosensitive member 1 preferably include no protective layer. The photosensitive member 1 has been described so far with reference to FIGS. 1 and 2.

The photosensitive member according to an embodiment of the present disclosure is excellent in sensitivity and abrasion resistance and can inhibit band generation caused due to high humidity. Presumably, the reason therefor is as follows. Band generation caused due to high humidity will be described first. When a photosensitive member is used in an extremely high humidity environment, condensation may occur on a part of the photosensitive member in contact with another component (for example, a charging roller) and the like. In a region of the photosensitive member where condensation occurs, moisture tends to penetrate into the charge generating layer through the charge transport layer with a result that sensitivity of the region may reduce as compared to that of any other regions of the photosensitive member. A smear generated on an image due to occurrence of such a phenomenon is called band generation caused due to high humidity. In order to inhibit band generation caused due to high humidity, moisture resistance at a rather higher level than that required for known photosensitive members is required.

The charge generating layer of the photosensitive member according to the embodiment of the present disclosure has a thickness of at least 0.07 μm, which is relatively thick. As a result of the charge generating layer being relatively thick as above, moisture penetration into a region of the charge generating layer close to the conductive substrate can be inhibited even upon occurrence of condensation on a surface of the photosensitive member (a region of the charge generating layer that moisture affects can be limited to a region thereof located close to the charge transport layer). Furthermore, meta-terphenyl, which is a filling, is added to the charge transport layer of the photosensitive member in the embodiment of the present disclosure. Therefore, moisture permeability of the charge transport layer can be reduced. The photosensitive member according to the embodiment of the present disclosure satisfies at least two of conditions (A) to (C) described above. When the thickness of the charge generating layer is further increased to 0.12 μm or larger as indicated in condition (A), moisture permeability of a region of the charge generating layer close to the conductive substrate can be further effectively inhibited. When fluororesin particles are added to the charge transport layer as filler particles as indicated in condition (B), hydrophobicity can be imparted to the charge transport layer to reduce moisture permeability. When the charge transport layer contains a relatively large amount of meta-terphenyl as indicated in condition (C), moisture permeability of the charge transport layer can be further reduced. However, a case where the charge generating layer is excessively increased in thickness, a case where the fluororesin particles are excessively added to the charge transport layer, or a case where meta-terphenyl is excessively added to the charge transport layer tends to involve sensitivity reduction, cost increase, and the like. Also, there is a limit in improvement in moisture resistance. The photosensitive member according to the embodiment of the present disclosure includes a charge generating layer that has an appropriate thickness and a charge transport layer that contains an appropriate amount of meta-terphenyl and to which a specific amount of fluorine particles are added. Thus, the photosensitive member can inhibit band generation caused due to high humidity while exhibiting excellent sensitivity. The polyarylate resin (PA) is excellent in strength due to inclusion of the repeating units (1) and (2), and has reduced frictional resistance and increased abrasion resistance due to having the terminal group (3) including a fluorine atom. Therefore, the photosensitive member according to the embodiment of the present disclosure is excellent in sensitivity and abrasion resistance and can inhibit band generation caused due to high humidity.

The photosensitive member according to the embodiment of the present disclosure may satisfy among conditions (A) to (C) only conditions (A) and (B), only conditions (A) and (C), only conditions (B) and (C), or all of conditions (A) to (C). The photosensitive member according to the embodiment of the present disclosure preferably satisfies condition (A) and at least one of conditions (B) and (C).

### [Conductive Substrate]

No specific limitations are placed on the conductive substrate other than being a conductive substrate that can be used as a conductive substrate of a photosensitive member. It is only required that at least a surface portion of the conductive substrate is made from a conductive material. An example of the conductive substrate is a conductive substrate made only from a material having conductivity. Another example of the conductive substrate is a conductive substrate made from a non-conductive material covered with a material having conductivity. Examples of the material having conductivity include aluminum, iron, copper, tin, platinum, silver, vanadium, molybdenum, chromium, cadmium, titanium, nickel, palladium, indium, and alloys including any of the above-listed materials (for example, aluminum alloy, stainless steel, and brass). In terms of increasing charge mobility from the photosensitive layer to the conductive substrate, aluminum or an aluminum alloy is preferable as the material having conductivity.

The conductive substrate is not limited to being in any particular shape, and the shape thereof can be selected appropriately according to the configuration of an image forming apparatus in which the conductive substrate is to be used. The conductive substrate is in for example a sheet shape or a drum shape. The thickness of the conductive substrate is selected appropriately according to the shape of the conductive substrate.

### [Photosensitive Layer]

The photosensitive layer is disposed either directly or indirectly on the conductive substrate. The photosensitive layer includes the charge generating layer and the charge transport layer disposed in stated order from a side of the conductive substrate.

### [Charge Generating Layer]

The charge generating layer contains a charge generating material. The charge generating layer may contain a binder resin for charge generating layer formation (also referred to below as a “base resin”). The charge generating layer may contain an additive as needed.

### (Charge Generating Material)

Examples of the charge generating material include phthalocyanine-based pigments, perylene-based pigments, bisazo pigments, tris-azo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (specific examples include selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridon-based pigments.

Examples of the phthalocyanine-based pigments include metal-free phthalocyanine and metal phthalocyanines. Examples of metal phthalocyanines include titanyl phthalocyanine, hydroxygallium phthalocyanine, and chlorogallium phthalocyanine. Metal-free phthalocyanine is represented by chemical formula (CGM-1) shown below. Titanyl phthalocyanine is represented by chemical formula (CGM-2) shown below.

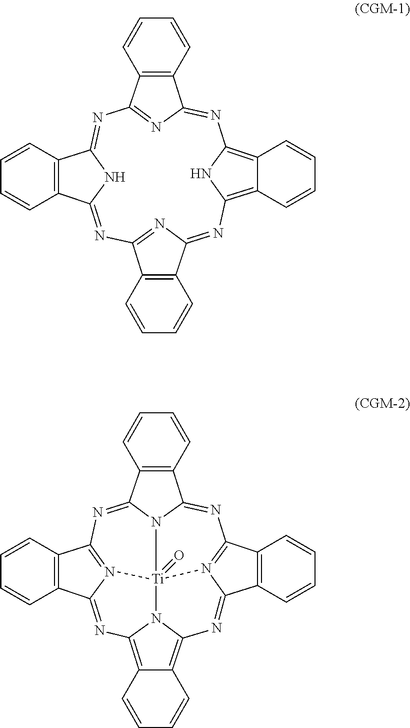

The phthalocyanine-based pigments may be crystalline or non-crystalline. An example of crystalline metal-free phthalocyanine is metal-free phthalocyanine having a crystal structure of X form (also referred to below as “X-form metal-free phthalocyanine”). An example of crystalline titanyl phthalocyanine is titanyl phthalocyanine having an α-form, β-form, or Y-form crystal structure (also referred to below as α-form, β-form, or Y-form titanyl phthalocyanine, respectively).

Y-form titanyl phthalocyanine crystals exhibit a main peak for example at a Bragg angle (2θ±0.2°) of 27.2° in a CuKα characteristic X-ray diffraction spectrum. Also, α-form titanyl phthalocyanine crystals exhibit a main peak for example at a Bragg angle (2θ±0.2°) of 28.6° in a CuKα characteristic X-ray diffraction spectrum.

The term main peak refers to a most intense or second most intense peak within a range of Bragg angles (2θ±0.2°) from 3° to 40° in a CuKα characteristic X-ray diffraction spectrum.

An example of a method for measuring the CuKα characteristic X-ray diffraction spectrum is described below. A sample (titanyl phthalocyanine) is loaded into a sample holder of an X-ray diffraction spectrometer (for example, “RINT (registered Japanese trademark) 1100”, product of Rigaku Corporation) and an X-ray diffraction spectrum is measured using a Cu X-ray tube, a tube voltage of 40 kV, a tube current of 30 mA, and X-ray characteristics of CuKα having a wavelength of 1.542 Å. The measurement range (2θ) is for example from 3° to 40° (start angle 3°, stop angle 40°), and the scanning speed is for example 10°/minute.

For a digital optical image forming apparatus (for example, a laser beam printer or facsimile machine that uses a light source such as a semiconductor laser), a photosensitive member that is sensitive to a range of wavelengths of 700 nm or longer is preferably used. A phthalocyanine-based pigment, which has a high quantum yield in a wavelength range of 700 nm or longer, is preferable as the charge generating material. Metal-free phthalocyanine or titanyl phthalocyanine is more preferable, X-form metal-free phthalocyanine or Y-form titanyl phthalocyanine is further referable, and Y-form titanyl phthalocyanine is particularly preferable.

For a photosensitive member used in an image forming apparatus that uses a short-wavelength laser light source (for example, a laser light source having an approximate wavelength of 350 nm or longer and 550 nm or shorter), an anthanthrone-based pigment is preferably used as the charge generating material.

In terms of further improving sensitivity of the photosensitive member, a content of the charge generating material in the charge generating layer is preferably at least 5.0 parts by mass and no greater than 1,000.0 parts by mass relative to 100 parts by mass of the base resin, and more preferably at least 30.0 parts by mass and no greater than 500.0 parts by mass.

### (Base Resin)

Examples of the base resin include thermoplastic resins, thermosetting resins, and photocurable resins. Examples of thermoplastic resins include polycarbonate resins, polyarylate resins, styrene-butadiene copolymers, styrene-acrylonitrile copolymers, styrene-maleate copolymers, acrylic acid polymers, styrene-acrylate copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, urethane resins, polysulfone resins, diallyl phthalate resins, ketone resins, polyvinyl butyral resins, polyester resins, polyvinyl acetal resins, and polyether resins. Examples of thermosetting resins include silicone resins, epoxy resins, phenolic resins, urea resins, and melamine resins. Examples of photocurable resins include acrylic acid adducts of epoxy compounds and acrylic acid adducts of urethane compounds. A preferable base resin is a polyvinyl acetal resin.

### (Additive)

Examples of additives that may be used include antidegradants (for example, antioxidants, radical scavengers, singlet quenchers, and ultraviolet absorbing agents), softeners, surface modifiers, extenders, thickeners, dispersion stabilizers, waxes, acceptors compounds (for example, an electron acceptor compound), donors, surfactants, plasticizers, sensitizers, and leveling agents. Examples of the antioxidants include hindered phenol compounds, hindered amine compounds, thioether compounds, and phosphite compounds. An example of the leveling agents is dimethyl silicone oil. An example of the sensitizers is meta-terphenyl.

### [Charge Transport Layer]

The charge transport layer contains a binder resin, a hole transport material, and meta-terphenyl. The charge transport layer further contains fluororesin particles according to necessity. The binder resin includes the polyarylate resin (PA).

### (Polyarylate Resin (PA))

The polyarylate resin (PA) has a main chain and the terminal group (3). The following describes the main chain and the terminal group (3) of the polyarylate resin (PA).

The main chain of the polyarylate resin (PA) includes at least one type of repeating unit (1) and at least one type of repeating unit (2).

The main chain of the polyarylate resin (PA) has no halogen atom. It is thought that as a result of the terminal group (3) having a fluorine atom and the main chain having no halogen atom in the polyarylate resin (PA), the polyarylate resin (PA) is excellent in compatibility with a hole transport material and crystallization of the photosensitive layer can be inhibited. Furthermore, it is thought that as a result of the terminal group (3) having a fluorine atom and the main chain having no halogen atoms in the polyarylate resin (PA), main chains are readily entangled, thereby increasing mechanical strength of the photosensitive layer.

The following describes the repeating unit (1). In general formula (1), an alkyl group having a carbon number of at least 1 and no greater than 4 that may be represented by R⁵ or R⁶ is preferably a methyl group or an ethyl group.

In general formula (X), t is preferably 1 or 2, and more preferably 2.

In a case where R⁵ and R⁶ in general formula (1) are bonded to each other to form a divalent group represented by general formula (X), it is preferable that R¹ and R³ each represent a methyl group and R² and R⁴ each represent a hydrogen atom.

The repeating unit (1) is preferably a repeating unit represented by chemical formula (1-1), (1-2), (1-3), or (1-4) shown below (also referred to below as a repeating unit (1-1), (1-2), (1-3), or (1-4), respectively).

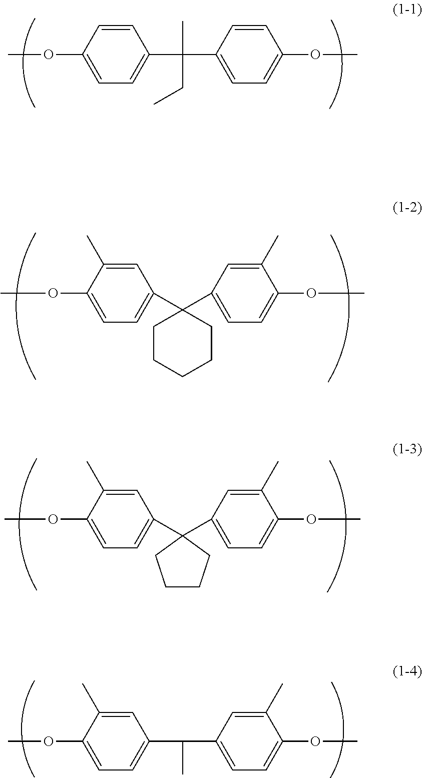

The polyarylate resin (PA) may include only one type of repeating unit (1) or two or more (for example, two) types of repeating units (1) as the repeating unit (1).

In a case where the polyarylate resin (PA) includes two types of repeating units (1) as the repeating unit (1), a ratio of the number of repeating unites (1) of one type to a total number of repeating units (1) of the two types (also referred to below as a ratio r) is preferably at least 0.10 and no greater than 0.90.

The following describes the repeating unit (2). The repeating unit (2) is preferably a repeating unit represented by general formula (2-1) or (2-2) shown below (also referred to below as a repeating unit (2-1) or (2-2), respectively). In general formula (2-2) shown below, X² represents a divalent group represented by chemical formula (2A), (2B), or (2D).

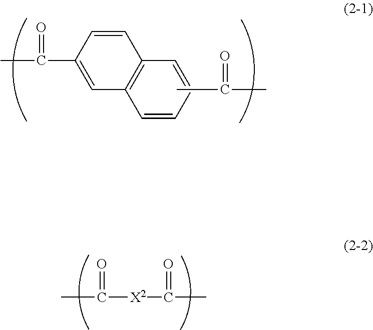

The repeating unit (2-1) is preferably a repeating unit represented by chemical formula (2-1C) shown below. The repeating unit (2-2) is preferably a repeating unit represented by chemical formula (2-2A), (2-2B), or (2-2D) shown below. In the following description, the repeating units represented by chemical formula (2-1C), (2-2A), (2-2B), and (2-2D) shown below may be referred to as repeating units (2-1C), (2-2A), (2-2B), and (2-2D), respectively.

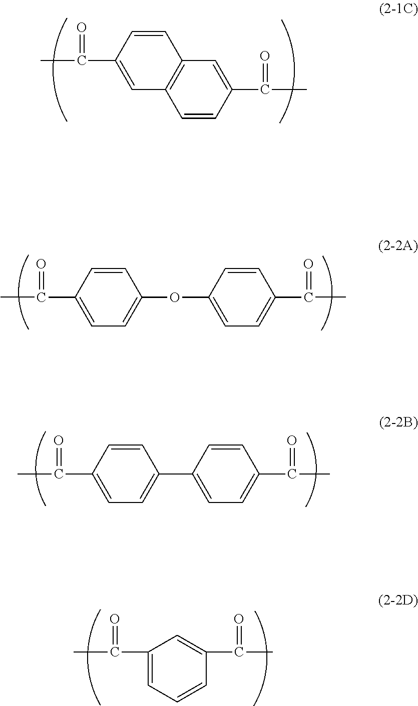

The polyarylate resin (PA) may include only one type of repeating unit (2) or two or more (for example, two) types of repeating units (2) as the repeating unit (2). In a case where the polyarylate resin (PA) includes one type of repeating unit (2) as the repeating unit (2), X¹ in general formula (2) preferably represents a divalent group represented by chemical formula (2A), (2B), or (2C).

In terms of increasing abrasion resistance of the photosensitive member, the polyarylate resin (PA) preferably includes two or more types of repeating units (2) as the repeating unit (2), and further preferably includes the repeating unit (2-1) and the repeating unit (2-2). For the same reason as above, the polyarylate resin (PA) particularly preferably includes only one type of repeating units (2-1) and one type of repeating units (2-2) as the repeating unit (2).

In a case where the polyarylate resin (PA) includes two or more types of repeating units (2) as the repeating unit (2), examples of a preferable combination of the two or more types of repeating units (2) include a combination of the repeating unit (2-1C) and the repeating unit (2-2A), a combination of the repeating unit (2-1C) and the repeating unit (2-2B), and a combination of the repeating unit (2-1C) and the repeating unit (2-2D).

In terms of further increasing abrasion resistance of the photosensitive member, a ratio of the number of repeating units (2-1) to a total number of the repeating units (2) of all types (also referred to below as a ratio p) is preferably at least 0.05 and less than 1.00, more preferably at least 0.20 and no greater than 0.80, and further preferably at least 0.40 and no greater than 0.60.

The ratio p and the ratio r described above are each an average value of values obtained from the entirety (a plurality of molecular chains) of the polyarylate resin (PA) contained in the photosensitive layer, rather than a value obtained from one molecular chain. Each ratio of the repeating units can be calculated from a ¹H-NMR spectrum of the polyarylate resin (PA) plotted using a proton nuclear magnetic resonance spectrometer.

The terminal group (3) is described next. A chain aliphatic group substituted with a fluorine atom represented by R^{f} of general formula (3) is for example a straight chain or branched chain group. The number of fluorine atoms with which the chain aliphatic group is substituted is for example at least 1 and no greater than 13. Note that the terminal group (3) is an acyclic group. As a result of the terminal group (3) being a chain aliphatic group rather than a cyclic group, abrasion resistance of the photosensitive member can be increased. The “chain aliphatic group” herein means a monovalent chain hydrocarbon group (particularly, an alkyl group) or a group formed by inserting —O— between a carbon-carbon bond of a chain hydrocarbon group.

The terminal group (3) is preferably a terminal group represented by general formula (3-1) shown below (also referred to below as a terminal group (3-1)). As a result of the polyarylate resin (PA) having the terminal group (3-1), a surface of the photosensitive layer can have further reduced frictional resistance, thereby further increasing abrasion resistance of the photosensitive member.

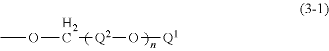

In general formula (3-1), Q¹ represents a straight chain or branched chain perfluoroalkyl group having a carbon number of at least 1 and no greater than 6. Q² represents a straight chain or branched chain perfluoroalkylene group having a carbon number of at least 1 and no greater than 6. n represents an integer of no less than 0 and no greater than 2. In a case where n represents 2, two groups Q² may be the same as or different from each other.

The perfluoroalkyl group represented by Q¹ in general formula (3-1) is preferably a straight chain or branched chain perfluoroalkyl group having a carbon number of at least 3 and no greater than 6, more preferably a straight chain perfluoroalkyl group having a carbon number of at least 3 and no greater than 6, and further preferably a heptafluoro n-propyl group or a tridecafluoro n-hexyl group.

The perfluoroalkylene group represented by Q² in general formula (3-1) is preferably a straight chain or branched chain perfluoroalkylene group having a carbon number of 2 or 3, and more preferably a 1-fluoro-1-trifluoromethyl-methylene group or 1,1,2-trifluoro-2-trifluoromethyl-ethylene group.

Preferably, n represents 0 or 2.

In terms of further increasing abrasion resistance of the photosensitive member, the terminal group (3) is preferably a terminal group represented by chemical formula (M1), (M2), (M3), or (M4) shown below (also referred to below as a terminal group (M1), (M2), (M3), or (M4), respectively).

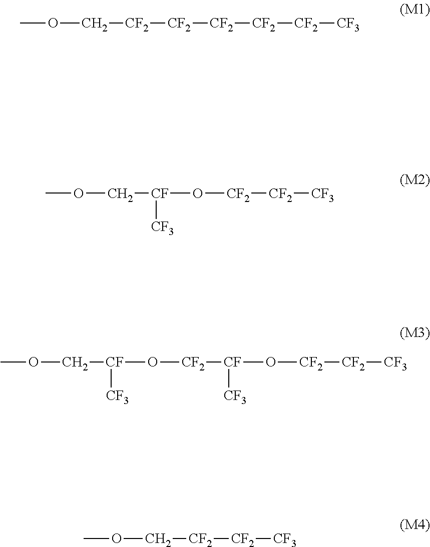

In terms of further increasing abrasion resistance of the photosensitive member, the terminal group (3) is preferably the terminal group (M1), (M3), or (M4). Frictional resistance of the surface of the photosensitive layer tends to decrease as the terminal group (3) has a longer carbon chain and a larger number of fluorine atoms). For the reasons as above, the terminal group (3) is further preferably the terminal group (M1) or (M3), and particularly preferably the terminal group (M3).

Examples of a preferable combination of the repeating unit (1), the repeating unit (2), and the terminal group (3) in the polyarylate resin (PA) include combinations (j-1) to (j-11) listed in Table 1 below.

Note that in Table 1 below, “Unit (1)”, “Unit (2)”, and “Group (3)” respectively represent the repeating unit (1), the repeating unit (2), and the terminal group (3). In Table 1 below, two repeating units listed under Unit (1) or Unit (2) indicate that both the repeating units are included. Specifically, “1-2/1-3” for example in Table 1 below indicates that both the repeating units (1-2) and (1-3) are included. The same as the above description is applied to Tables 2 to 4 below.

TABLE 1

| Combination | Unit (1) | Unit (2) | Group (3) |
|---|---|---|---|
| j-1 | 1-1 | 2-1C/2-2A | M1 |
| j-2 | 1-1 | 2-1C/2-2B | M1 |
| j-3 | 1-2 | 2-1C/2-2A | M1 |
| j-4 | 1-2/1-3 | 2-1C/2-2A | M1 |
| j-5 | 1-2 | 2-1C/2-2B | M1 |
| j-6 | 1-2 | 2-1C/2-2D | M1 |
| j-7 | 1-4 | 2-1C/2-2A | M1 |
| j-8 | 1-1 | 2-2A | M1 |
| j-9 | 1-1 | 2-1C/2-2A | M2 |
| j-10 | 1-1 | 2-1C/2-2A | M3 |
| j-11 | 1-1 | 2-1C/2-2A | M4 |

The polyarylate resin (PA) is preferably any of polyarylate resins (R-1-M1) to (R-10-M1) and (R-1-M2) to (R-1-M4) listed in Table 2 below.

TABLE 2

| Polyarylate resin | Unit (1) | Unit (2) | Group (3) | Ratio p |
|---|---|---|---|---|
| R-1-M1 | 1-1 | 2-1C/2-2A | M1 | 0.50 |
| R-2-M1 | 1-1 | 2-1C/2-2B | M1 | 0.50 |
| R-3-M1 | 1-2 | 2-1C/2-2A | M1 | 0.50 |
| R-4-M1 | 1-2 | 2-1C/2-2A | M1 | 0.30 |
| R-5-M1 | 1-2/1-3 | 2-1C/2-2A | M1 | 0.10 |
| R-6-M1 | 1-2 | 2-1C/2-2B | M1 | 0.50 |
| R-7-M1 | 1-2 | 2-1C/2-2D | M1 | 0.50 |
| R-8-M1 | 1-4 | 2-1C/2-2A | M1 | 0.50 |
| R-9-M1 | 1-1 | 2-2A | M1 | — |
| R-10-M1 | 1-2 | 2-1C/2-2A | M1 | 0.70 |
| R-1-M2 | 1-1 | 2-1C/2-2A | M2 | 0.50 |
| R-1-M3 | 1-1 | 2-1C/2-2A | M3 | 0.50 |
| R-1-M4 | 1-1 | 2-1C/2-2A | M4 | 0.50 |

A repeating unit derived from an aromatic diol and a repeating unit derived from an aromatic dicarboxylic acid are adjacent and bonded to each other in the polyarylate resin (PA). The terminal group (3) is adjacent and bonded to the repeating unit derived from the aromatic dicarboxylic acid in the polyarylate resin (PA). In the above structure, the number N_{BP} of the repeating units derived from the aromatic diol and the number N_{DC} of the repeating units derived from the aromatic dicarboxylic acid satisfy an equation “N_{DC}=N_{BP}+1” in the polyarylate resin (PA). In a case where the polyarylate resin (PA) is a copolymer, the polyarylate resin (PA) may be a random copolymer, an alternating copolymer, a periodic copolymer, or a block copolymer, for example.

The repeating unit derived from the aromatic diol is for example the repeating unit (1). In a case where the polyarylate resin (PA) includes two or more types of repeating units (1), no particular limitations are placed on a sequence of one type of repeating unit (1) and the other type(s) of repeating unit(s) (1). The one type of repeating unit (1) and the other type(s) of repeating unit(s) (1) can be arranged randomly, alternately, periodically, or on a block-by-block basis through the repeating unit (2). The repeating unit derived from the aromatic dicarboxylic acid is for example the repeating unit (2). In a case where the polyarylate resin (PA) includes two or more types of repeating units (2), no particular limitations are placed on a sequence of one type of repeating unit (2) and the other type(s) of repeating unit(s) (2). The one type of repeating unit (2) and the other type(s) of repeating unit(s) (2) can be arranged randomly, alternately, cyclically, or on a block-by-block bases through the repeating unit (1).

Preferably, the polyarylate resin (PA) includes only the repeating units (1) and (2) as repeating units. However, the polyarylate resin (PA) may further include either or both a repeating unit derived from an aromatic diol other than the repeating unit (1) and a repeating unit derived from an aromatic dicarboxylic acid other than the repeating unit (2).

The polyarylate resin (PA) has a viscosity average molecular weight preferably of at least 10,000, more preferably of at least 20,000, further preferably of at least 30,000, and particularly preferably of at least 40,000. As a result of the polyarylate resin (PA) having a viscosity average molecular weight of at least 10,000, abrasion resistance of the polyarylate resin (PA) can be further increased. The polyarylate resin (PA) has a viscosity average molecular weight preferably of no greater than 80,000, and more preferably of no greater than 70,000. As a result of the polyarylate resin (PA) having a viscosity average molecular weight of no greater than 80,000, the polyarylate resin (PA) is easy to dissolve in a solvent for charge transport layer formation. Thus, formation of the charge transport layer can be facilitated.

Although no particular limitations are placed on a production method of the polyarylate resin (PA), an example of the production method is condensation polymerization of an end terminator for forming the terminal group (3) and an aromatic diol and an aromatic dicarboxylic acid for forming the main chain. A known synthesis method (specific examples include solution polymerization, melt polymerization, and interface polymerization) can be selected for a condensation polymerization method.

The aromatic diol for forming the main chain is represented by general formula (BP-1) shown below, for example. The aromatic dicarboxylic acid for forming the main chain is represented by general formula (DC-2) shown below, for example. The end terminator for forming the terminal group (3) is represented by general formula (T-3) shown below, for example. In general formulas (BP-1), (DC-2), and (T-3) shown below, R¹, R², R³, R⁴, R⁵, R⁶, X¹, and R^{f} respectively represent the same as R¹, R², R³, R⁴, R⁵, R⁶, X¹, and R^{f} in general formulas (1), (2), and (3). In the following description, compounds represented by general formulas (BP-1), (DC-2), and (T-3) shown below may be referred to as compounds (BP-1), (DC-2), and (T-3), respectively.

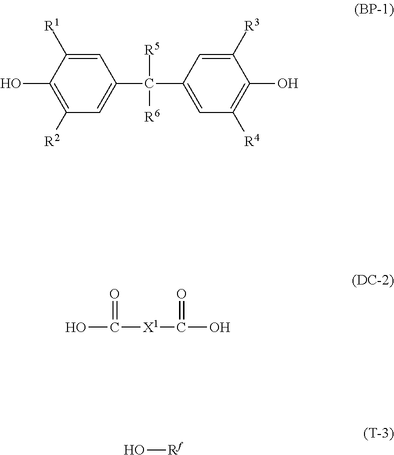

Compounds represented by chemical formulas (BP-1-1) to (BP-1-4) shown below (also referred to below as compounds (BP-1-1) to (BP-1-4), respectively) are preferable as the compound (BP-1).

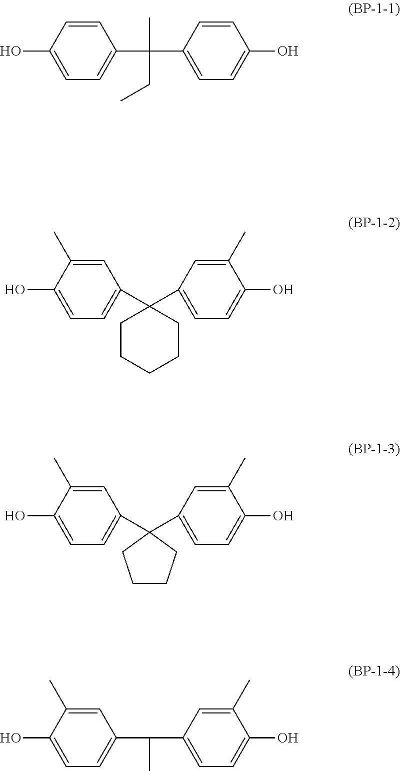 [SMILES: CCC(C)(c1ccc(O)cc1)c1ccc(O)cc1 ; Cc1cc(C2(c3ccc(O)c(C)c3)CCCCC2)ccc1O ; Cc1cc(C2(c3ccc(O)c(C)c3)CCCC2)ccc1O ; Cc1cc(C(C)c2ccc(O)c(C)c2)ccc1O]

Examples of the compound (DC-2) include compounds represented by chemical formulas (DC-2-1C), (DC-2-2A), (DC-2-2B), and (DC-2-2D) shown below (also referred to below as compounds (DC-2-1C), (DC-2-2A), (DC-2-2B), and (DC-2-2D), respectively).

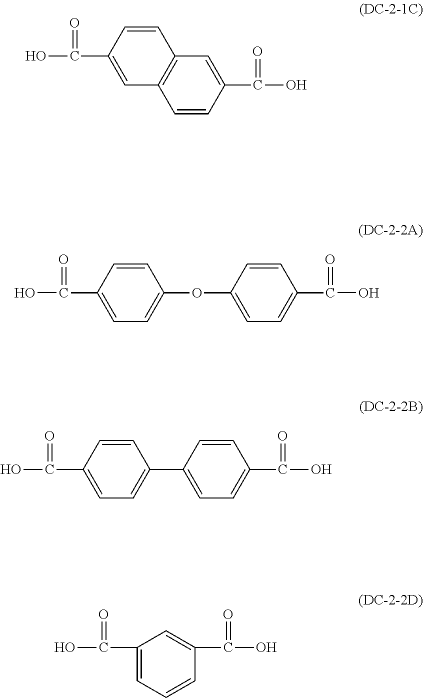 [SMILES: O=C(O)c1ccc2cc(C(=O)O)ccc2c1 ; O=C(O)c1ccc(Oc2ccc(C(=O)O)cc2)cc1 ; O=C(O)c1ccc(-c2ccc(C(=O)O)cc2)cc1 ; O=C(O)c1cccc(C(=O)O)c1]

Preferable examples of the compound (T-3) include compounds represented by chemical formulas (T-M1) to (T-M4) shown below (also referred to below as compounds (T-M1) to (T-M4), respectively).

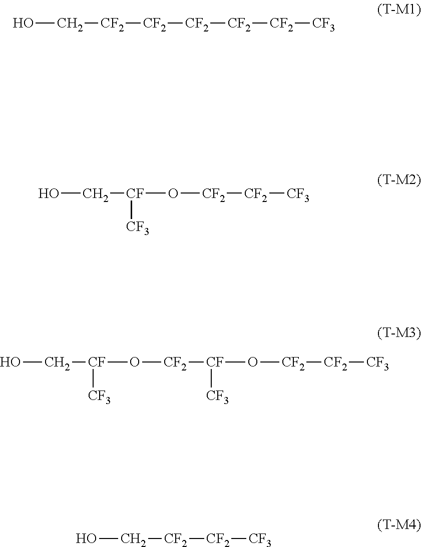

The aromatic diol forming the main chain (for example, the compound (BP-1)) may be transformed for use into an aromatic diacetate. The aromatic dicarboxylic acid for forming the main chain (for example, the compound (DC-2)) may be derivatized for use. Examples of a derivative of the aromatic dicarboxylic acid include aromatic dicarboxylic acid dichloride, aromatic dicarboxylic acid dimethyl ester, aromatic dicarboxylic acid diethyl ester, and aromatic dicarboxylic acid anhydride. The aromatic dicarboxylic acid dichloride is a compound obtainably by replacing two “—C(═O)—OH” groups as the aromatic dicarboxylic acid each substituted with a “—C(═O)—Cl” group.

Either or both a base and a catalyst may be added in condensation polymerization of the aromatic diol and the aromatic dicarboxylic acid. The base and the catalyst may be respectively selected from known bases and known catalysts as appropriate. An example of the base is sodium hydroxide. Examples of the catalyst include benzyltributylammonium chloride, ammonium chloride, ammonium bromide, quaternary ammonium salt, triethylamine, and trimethylamine.

The binder resin preferably includes only the polyarylate resin (PA). However, the binder resin may additionally include a binder resin other than the polyarylate resin (PA) (also referred to below as an additional binder resin). A content of the polyarylate resin (PA) in the binder resin is preferably at least 80% by mass, more preferably 90% by mass, and particularly preferably 100% by mass. Examples of the additional binder resin include the same resins as those listed as the examples of the base resin.

The charge transport layer contains the polyarylate resin (PA) preferably in an amount of at least 50% by mass and no greater than 85% by mass, and more preferably in an amount of at least 60% by mass and no greater than 70% by mass. As a result of the charge transport layer containing the polyarylate resin (PA) in an amount of at least 50% by mass and no greater than 85% by mass, abrasion resistance of the photosensitive member can be further increased.

### (Hole Transport Material)

Examples of the hole transport material include triphenylamine derivatives, diamine derivatives (for example, an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and a di(amino phenylethenyl)benzene derivative), oxadiazole-based compounds (for example, 2,5-di(4-methylaminophenyl)-1,3,4-oxadiazole), styryl-based compounds (for example, 9-(4-diethylaminostyryl)anthracene), carbazole-based compounds (for example, polyvinyl carbazole), organic polysilane compounds, pyrazoline-based compounds (for example, 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

The hole transport material preferably contains a compound represented by general formula (10) shown below (also referred to below as a hole transport material (10)). As a result of the charge transport layer containing the hole transport material (10), abrasion resistance and sensitivity of the photosensitive member can be further increased.

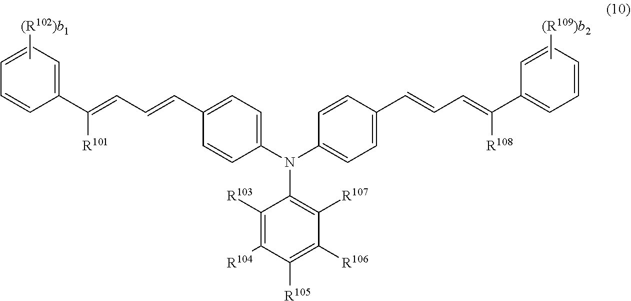

In general formula (10), R¹⁰¹, R¹⁰³, R¹⁰⁴, R¹⁰⁵, R¹⁰⁶, R¹⁰⁷, and R¹⁰⁸ each represent, independently of one another, a hydrogen atom, an alkyl group having a carbon number of at least 1 and no greater than 8, a phenyl group optionally substituted with an alkyl group having a carbon number of at least 1 and no greater than 8, or an alkoxy group having a carbon number of at least 1 and no greater than 8. Two adjacent groups among R¹⁰³, R¹⁰⁴, R¹⁰⁵, R¹⁰⁶, and R¹⁰⁷ may be bonded to each other to form a cycloalkane having a carbon number of at least 5 and no greater than 7. R¹⁰² and R¹⁰⁹ each represent, independently of one another, a phenyl group, an alkyl group having a carbon number of at least 1 and no greater than 8, or an alkoxy group having a carbon number of at least 1 and no greater than 8. b₁ and b₂ each represent, independently of one another, an integer of at least 0 and no greater than 5.

An alkyl group represented by R¹⁰¹ to R¹⁰⁹ in general formula (10) is preferably an alkyl group having a carbon number of at least 1 and no greater than 6, more preferably an alkyl group having a carbon number of at least 1 and no greater than 4, and further preferably a methyl group or an n-butyl group.

A phenyl group that may be represented by R¹⁰¹ to R¹⁰⁹ in general formula (10) may be substituted with an alkyl group having a carbon number of at least 1 and no greater than 8. An alkyl group with which a phenyl group is substituted is preferably an alkyl group having a carbon number of at least 1 and no greater than 6, more preferably an alkyl group having a carbon number of at least 1 and no greater than 4, and further preferably a methyl group.

An alkoxy group that may be represented by R¹⁰¹ to R¹⁰⁹ in general formula (10) is preferably an alkoxy group having a carbon number of at least 1 and no greater than 4, and further preferably a methoxy group or an ethoxy group.

In general formula (10), two adjacent groups among R¹⁰³, R¹⁰⁴, R¹⁰⁵, R¹⁰⁶, and R¹⁰⁷ may be bonded to each other to form a cycloalkane having a carbon number of at least 5 and no greater than 7. For example, R¹⁰⁶ and R¹⁰⁷ among R¹⁰³, R¹⁰⁴, R¹⁰⁵, R¹⁰⁶, and R¹⁰⁷ may be bonded to each other to form a cycloalkane having a carbon number of at least 5 and no greater than 7. In a case where two adjacent groups among R¹⁰³, R¹⁰⁴, R¹⁰⁵, R¹⁰⁶, and R¹⁰⁷ are bonded to each other to form a cycloalkane having a carbon number of at least 5 and no greater than 7, the cycloalkane condensates with the phenyl group to which R¹⁰³, R¹⁰⁴, R¹⁰⁵, R¹⁰⁶, and R¹⁰⁷ are bonded to form a fused bi-cyclic group. In this case, a condensation site of the cycloalkane and the phenyl group may have a double bond. Cyclohexane is preferable as a cycloalkane formed by two adjacent groups bonded to each other among R¹⁰³, R¹⁰⁴, R¹⁰⁵, R¹⁰⁶, and R¹⁰⁷.

In a case where b₁ represents an integer of at least 2 and no greater than 5, plural groups R¹⁰² may be the same as or different from one another. In a case where b₂ represents an integer of at least 2 and no greater than 5, plural groups R¹⁰⁹ may be the same as or different from one another. Preferably, b₁ and b₂ each represent, independently of one another, 0 or 1.

In general formula (10), R¹⁰¹ and R¹⁰⁸ preferably each represent a hydrogen atom. Preferably, R¹⁰² and R¹⁰⁹ each represent an alkyl group having a carbon number of at least 1 and no greater than 8. Preferably, R¹⁰³, R¹⁰⁴, R¹⁰⁶, and R¹⁰⁷ each represent a hydrogen atom. R¹⁰⁵ preferably represents an alkyl group having a carbon number of at least 1 and no greater than 8, and more preferably represents an n-butyl group. b₁ and b₂ preferably each represent 0.

The hole transport material (10) is preferably a compound represented by chemical formula (HTM-1) shown below (also referred to below as a hole transport material (HTM-1)).

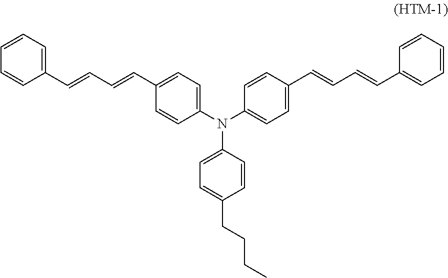 [SMILES: CCCCc1ccc(N(c2ccc(/C=C/C=C/c3ccccc3)cc2)c2ccc(/C=C/C=C/c3ccccc3)cc2)cc1]

The charge transport layer preferably contains the hole transport material (10) only as a hole transport material, but may further contain an additional hole transport material. A content of the hole transport material (10) in the hole transport material is preferably at least 80% by mass relative to a total mass of the hole transport material, more preferably at least 90% by mass, and particularly preferably 100% by mass.

A content of the hole transport material in the charge transport layer is preferably at least 10.0 parts by mass and no greater than 200.0 parts by mass relative to 100% parts by mass of the binder resin, and more preferably at least 20.0 parts by mass and no greater than 100.0 parts by mass.

### (Fluororesin Particles)

Examples of the fluororesin particles include polytetrafluoroethylene (PTFE) particles, perfluoro alkoxy alkane particles, perfluoro ethylene propene copolymer particles, ethylene-tetrafluoro ethylene copolymer particles, polyvinylidene fluoride particles, and polyvinyl fluoride particles. PTFE particles are preferable as the fluororesin particles.

The fluororesin particles preferably have an average primary particle diameter of at least 0.3 μm and no greater than 15.0 μm, and more preferably have an average primary particle diameter of at least 2.5 μm and no greater than 5.0 μm. As a result of the fluororesin particles having an average primary particle diameter of at least 0.3 μm and no greater than 15.0 μm, abrasion resistance and sensitivity of the photosensitive member can be increased in a well-balanced manner and band generation caused due to high humidity can be effectively inhibited. The average primary particle diameter of fluororesin particles herein means an arithmetic mean of equivalent circle diameters of equivalent areas (Heywood diameters) measured for 20 primary particles of fluororesin particles randomly selected from the fluororesin particles.

The fluororesin particles is preferably contained in the charge transport layer in an amount of at least 1.5 parts by mass and no greater than 11.0 parts by mass relative to 100 parts by mass of the binder resin, and more preferably contained in an amount of at least 3.0 parts by mass and no greater than 7.0 parts by mass. As a result of the fluororesin particles being contained in an amount of at least 1.5 parts by mass, band generation caused due to high humidity can be further effectively inhibited. As a result of the fluororesin particles being contained in an amount of no greater than 11.0 parts by mass, sensitivity of the photosensitive member can be further improved.

### (Meta-Terphenyl)

Meta-terphenyl is contained in the charge transport layer preferably in an amount of at least 1.0 parts by mass and no greater than 15.0 parts by mass relative to 100 parts by mass of the binder resin, more preferably in an amount of at least 5.0 parts by mass and no greater than 15.0 parts by mass, and further preferably in an amount of at least 9.0 parts by mass and no greater than 12.0 parts by mass. As a result of the meta-terphenyl being contained in an amount of at least 1.0 parts by mass, band generation caused due to high humidity can be further effectively inhibited. As a result of meta-terphenyl being contained in an amount of no greater than 15.0 parts by mass, sensitivity of the photosensitive member can be improved.

### (Additive)

Examples of additives that may be added to the charge transport layer are the same as those listed as the example of the additives that may be used in the charge generating layer. The charge transport layer preferably contains an antioxidant or an acceptor compound as an additive, and further preferably contains a hindered phenol compound or an electron acceptor compound.

A content of the antioxidant that may be added to the charge transport layer is preferably at least 0.1 parts by mass and no greater than 10.0 parts by mass relative to 100 parts by mass of the binder resin, and more preferably at least 0.5 parts by mass and no greater than 5.0 parts by mass.

Examples of the electron acceptor compound include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds.

A preferable electron acceptor compound is a compound represented by general formula (E-1) shown below.

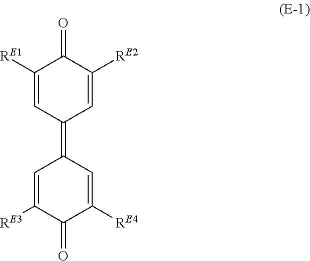

In general formula (E-1), R^{E1}, R^{E2}, R^{E3}, and R^{E4} each represent, independently of one another, an alkyl group having a carbon number of at least 1 and no greater than 6. Preferably, R^{E1}, R^{E2}, R^{E3}, and R^{E4} each represent, independently of one another, an alkyl group having a carbon number of at least 3 and no greater than 5.

A compound represented by chemical formula (ET1) shown below (also referred to below as an electron acceptor compound (ET1)) is preferable as the compound represented by general formula (E-1).

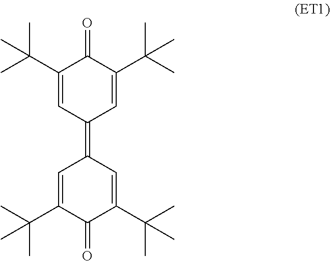

A content of the electron acceptor compound in the charge transport layer is preferably at least 0.1 parts by mass and no greater than 10.0 parts by mass relative to 100 parts by mass of the binder resin, and more preferably at least 0.5 parts by mass and no greater than 5.0 parts by mass.

### (Combination)

A preferable combination of the polyarylate resin (PA), the hole transport material, and the additive in the charge transport layer is: any one of the polyarylate resins (R-1-M1) to (R-10-M1) and (R-1-M2) to (R-1-M4); the hole transport material (HTM-1); and a hindered phenol compound and the electron acceptor compound (ET1) each as the additive.

### [Intermediate Layer]

The intermediate layer (undercoat layer) contains inorganic particles and a resin for intermediate layer formation (intermediate layer resin), for example. In presence of the intermediate layer, an insulation state to an extent that generation of a leakage current can be inhibited can be maintained and a current generated at light exposure on the photosensitive member can smoothly flow, thereby inhibiting an increase in resistance.

Examples of the inorganic particles include particles of metals (specific examples include aluminum, iron, and copper), particles of metal oxides (specific examples include titanium oxide, alumina, zirconium oxide, tin oxide, and zinc oxide), and particles of non-metal oxides (for example, silica).

No specific limitations are placed on the intermediate layer resin other than being a resin that can be used to form an intermediate layer. The intermediate layer may contain an additive. Examples of the additive that may be contained in the intermediate layer are the same as those listed as the example of the additives that may be contained in the photosensitive layer.

### <Photosensitive Member Production Method>

Examples of a production method for the photosensitive member according to the present embodiment is a production method involving a charge generating layer formation process and a charge transport layer formation process. In the charge generating layer formation process, an application liquid for forming a charge generating layer (also referred to below as an application liquid for charge generating layer formation) is prepared first. The application liquid for charge generating layer formation is then applied onto a conductive substrate. Subsequently, at least a portion of a solvent contained in the applied application liquid for charge generating layer formation is removed to form a charge generating layer. The application liquid for charge generating layer formation contains for example a charge generating material, a base resin, and the solvent. An application liquid for charge generating layer formation such as above is prepared by dissolving or dispersing the charge generating material and the base resin in the solvent. The application liquid for charge generating layer formation may contain an additive as needed.

In the charge transport layer formation process, an application liquid for forming a charge transport layer (also referred to below as an application liquid for charge transport layer formation) is prepared first. The application liquid for charge transport layer formation is then applied onto the charge generating layer. Subsequently, at least a portion of a solvent contained in the applied application liquid for charge transport layer formation is removed to form a charge transport layer. The application liquid for charge transport layer formation contains the hole transport material, the polyarylate resin (PA) as a binder resin, meta-terphenyl, and the solvent, and fluororesin particles which are added as needed. The application liquid for charge transport layer formation is prepared by dissolving or dispersing the polyarylate resin (PA) and meta-terphenyl, and fluororesin particles which are added as needed, in the solvent. An additive may be added to the application liquid for charge transport layer formation as needed.

No particular limitations are placed on each solvent contained in the application liquid for charge generating layer formation or the application liquid for charge transport layer formation (also referred to below simply as an application liquid) so long as the other components are dissoluble or dispersible therein. Examples of the solvent include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide. A non-halogen solvent (solvent other than halogenated hydrocarbon) is preferable as the solvent of each application liquid.

The solvent contained in the application liquid for charge transport layer formation and the solvent contained in the application liquid for charge generating layer formation are preferably different from each other. In this case, dissolution of the charge generating layer in the solvent of the application liquid for charge transport layer formation can be inhibited in application of the application liquid for charge transport layer formation on the charge generating layer.

Each of the application liquids is prepared by mixing the corresponding components in order to disperse the components in the solvent. Mixing or dispersion can be performed for example using a bead mill, a roll mill, a ball mill, an attritor, a paint shaker, or an ultrasonic disperser.

Each application liquid may further contain for example a surfactant or a leveling agent in order to increase dispersibility of the components or improve surface flatness of the formed layers.

No particular limitations are placed on a method by which the application liquid is applied so long as the method enables uniform application of the application liquid. Examples of the application method include dip coating, spray coating, spin coating, and bar coating.

No specific limitations are placed on a method by which at least a portion of the solvent in the application liquid is removed other than being a method that enables evaporation of the solvent in the application liquid. Specific examples of the method for removing the solvent include heating, pressure reduction, and a combination of heating and pressure reduction. One specific example of the method involves heat treatment (hot-air drying) using a high-temperature dryer or a reduced pressure dryer. The heat treatment is for example performed for 3 minutes or longer and 120 minutes or shorter at a temperature of 40° C. or higher and 150° C. or lower.

The photosensitive member production method may further involve an intermediate layer formation process as needed. Any known method can be selected as appropriate for the intermediate layer formation process.

### EXAMPLES

The following provides more specific description of the present disclosure through use of Examples. Note that the present disclosure is not in any way limited to the scope of the examples.

### (Additive)

Compounds represented by chemical formulas (ADD1) to (ADD4) shown below (also referred to below as additives (ADD1) to (ADD4), respectively) were used each as an additive (filling) added to a charge transport layer.

Additive (ADD1): Meta-terphenyl (“M-TP”, product of EVOMAX LTD.).

Additive (ADD2): 2-(5-Chloro-2-benzotriazolyl)-6-tert-butyl-p-cresol (“ADK STAB (registered Japanese trademark) LA-36”, product of ADEKA CORPORATION).

Additive (ADD3): Tris(p-tolyl)amine (“T-716”, product of TAKASAGO CHEMICAL CORPORATION).

Additive (ADD4): Dibutylhydroxytoluene (“H-BHT”, product of MIKI & CO., LTD.).

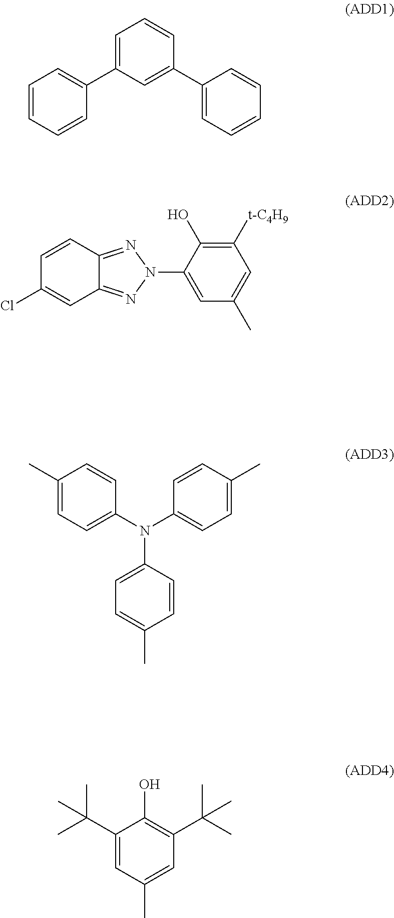

### (Filler Particles)

The following filler particles (F1) to (F7) were prepared. The filler particles (F1) to (F4) were fluororesin particles.

Filler particle (F1): PTFE particles, average primary particle diameter 3.5 μm, “LUBRON (registered Japanese trademark) L-2”, product of DAIKIN INDUSTRIES, LTD.

Filler particles (F2): PTFE particles, average primary particle diameter 0.6 μm, “KTL-500F”, product of KITAMURA LIMITED.

Filler particles (F3): PTFE particles, average primary particle diameter 3.0 μm, “KTL-1N”, product of KITAMURA LIMITED.

Filler particles (F4): PTFE particles, average primary particle diameter 10.0 μm, “KTL-10N”, product of KITAMURA LIMITED.

Filler particles (F5): Hydrophobic fumed silica particles, average primary particle diameter 0.007 μm, “AEROSIL (registered Japanese trademark) RX300”, product of Nippon Aerosil Co., Ltd.

Filler particles (F6): Silicone resin particles, average primary particle diameter 0.6 μm, “MSP-N050”, product of Nikko Rica Corporation.

Filler particles (F7): Silicone resin particles, average primary particle diameter 0.7 μm, “X52-854”, product of Shin-Etsu Chemical Co., Ltd.

### (Hole Transport Material)

The hole transport material (HTM-1) described in the embodiment was prepared as a hole transport material.

### (Binder Resin)

The polyarylate resins (R-1-M1) to (R-1-M4), (R-2-M1) to (R-10-M1), and (R-1-MA) were synthesized each as a binder resin. Of the polyarylate resins, the polyarylate resins (R-1-M1) to (R-1-M4) and (R-2-M1) to (R-10-M1) each were the polyarylate resin (PA) described in the embodiment. Tables 3 and 4 below list repeating units (1), repeating units (2), and terminal groups (3) included in the respective polyarylate resins and respective corresponding ratios p. In Table 4 below, “MA” under “Group (3)” represents a group represented by chemical formula (MA) shown below. Note that percentage yield of each polyarylate resin was obtained in terms of a molar ratio in the examples.

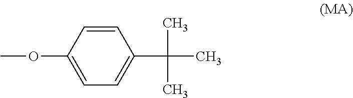

### (Synthesis of Polyarylate Resin (R-1-M1))

A 2-L three-necked flask equipped with a thermometer and a three-way cock was used as a reaction vessel in synthesis of the polyarylate resin (R-1-M1). The reaction vessel was charged with 20.01 g (82.56 mmol) of the compound (BP-1-1), 0.281 g (0.826 mmol) of the compound (T-M1), 7.84 g (196 mmol) of sodium hydroxide, and 0.240 g (0.768 mmol) of benzyltributylammonium chloride. The air in the reaction vessel was replaced with argon gas. The reaction vessel was further charged with 600 mL of water. The reaction vessel contents were stirred at 20° C. for 1 hour. Next, the resultant reaction vessel contents were cooled until the temperature of the reaction vessel contents became 10° C. to obtain an alkaline aqueous solution A.

Separately, 9.84 g (38.9 mmol) of 2,6-naphthalene dicarboxylic acid dichloride (dichloride of the compound (DC-2-1C)) and 11.47 g (38.9 mmol) of 4,4′-oxybis benzoic acid dichloride (dichloride of the compound (DC-2-2A)) were dissolved in 300 g of chloroform. Through the above, a chloroform solution B was obtained.

The chloroform solution B was added to the alkaline aqueous solution A in the reaction vessel while the alkaline aqueous solution A was stirred at a temperature of 10° C. Through the above, polymerization reaction was started. The resultant reaction vessel contents were stirred for 3 hours under adjustment of the temperature (liquid temperature) of the vessel contents to 13° C.±3° C. to cause polymerization reaction to proceed. Next, an upper layer (water layer) of the reaction vessel contents was removed by decantation to obtain an organic layer. Subsequently, 500 mL of ion exchanged water was added into a 2-L conical flask. The organic layer obtained as above was further added into the flask. Moreover, 300 g of chloroform and 6 mL of acetic acid were further added into the flask. Subsequently, the resultant flask contents were stirred for 30 minutes at room temperature. Thereafter, an upper layer (water layer) of the flask contents was removed by decantation to obtain an organic layer. The organic layer obtained as above was washed with 500 mL of ion exchanged water using a separatory funnel. The above washing with ion exchanged water was repeated 8 times to obtain a washed organic layer.

Subsequently, the washed organic layer was filtered to obtain a filtrate. Into a 3-L beaker, 1.5 L of methanol was added. The filtrate obtained as above was gradually dripped into the methanol in the beaker to obtain a precipitate. The precipitate was collected by filtration. The collected precipitate was vacuum-dried for 12 hours at a temperature of 70° C. Through the above, the polyarylate resin (R-1-M1) was obtained (mass yield 28.6 g, percentage yield 82.9%). The polyarylate resin (R-1-M1) had a viscosity average molecular weight of 50,500.

The polyarylate resins (R-1-M2) to (R-1-M4), (R-2-M1) to (R-10-M1), and (R-1-MA) were synthesized by the same method as that for the polyarylate resin (R-1-M1) in all aspects except the following changes.

### (Synthesis of Polyarylate Resin (R-2-M1))

In synthesis of the polyarylate resin (R-2-M1), dichloride of the compound (DC-2-2A) was changed to 38.9 mmol of dichloride of the compound (DC-2-2B). The resultant polyarylate resin (R-2-M1) had a mass yield of 27.8 g, a percentage yield of 82.1%, and a viscosity average molecular weight of 52,200.

### (Synthesis of Polyarylate Resin (R-3-M1))

In synthesis of the polyarylate resin (R-3-M1), the compound (BP-1-1) was changed to 82.56 mmol of the compound (BP-1-2). The resultant polyarylate resin (R-3-M1) had a mass yield of 31.0 g, a percentage yield of 80.1%, and a viscosity average molecular weight of 48,100.

### (Synthesis of Polyarylate Resin (R-4-M1))

In synthesis of the polyarylate resin (R-4-M1), the compound (BP-1-1) was changed to 82.56 mmol of the compound (BP-1-2). Further, in synthesis of the polyarylate resin (R-4-M1), the amount of dichloride of the compound (DC-2-1C) was changed to 23.3 mmol and the amount of dichloride of the compound (DC-2-2A) was changed to 54.5 mmol. The resultant polyarylate resin (R-4-M1) had a mass yield of 31.3 g, a percentage yield of 79.6%, and a viscosity average molecular weight of 47,600.

### (Synthesis of Polyarylate Resin (R-5-M1))

In synthesis of the polyarylate resin (R-5-M1), the compound (BP-1-1) was changed to 8.26 mmol of the compound (BP-1-2) and 74.0 mmol of the compound (BP-1-3). Furthermore, in synthesis of the polyarylate resin (R-5-M1), the amount of dichloride of the compound (DC-2-1C) was changed to 7.8 mmol and the amount of dichloride of the compound (DC-2-2A) was chanted to 70.0 mmol. The resultant polyarylate resin (R-5-M1) had a mass yield of 31.2 g, a percentage yield of 80.0%, and a viscosity average molecular weight of 49,500. The resultant polyarylate resin (R-5-M1) included two types of repeating units (1-2) and (1-3) as the repeating unit (1), of which a molar ratio (repeating unit (1-2): repeating unit (1-3)) was 1:9.

### (Synthesis of Polyarylate Resin (R-6-M1))

In synthesis of the polyarylate resin (R-6-M1), the compound (BP-1-1) was changed to 82.56 mmol of the compound (BP-1-2). In synthesis of the polyarylate resin (R-6-M1), dichloride of the compound (DC-2-2A) was changed to 38.9 mmol of dichloride of the compound (DC-2-2B). The resultant polyarylate resin (R-6-M1) had a mass yield of 30.5 g, a percentage yield of 76.8%, and a viscosity average molecular weight of 48,900.

### (Synthesis of Polyarylate Resin (R-7-M1))

In synthesis of the polyarylate resin (R-7-M1), the compound (BP-1-1) was changed to 82.56 mmol of the compound (BP-1-2). In synthesis of the polyarylate resin (R-7-M1), dichloride of the compound (DC-2-2A) was changed to 38.9 mmol of dichloride of the compound (DC-2-2D). The resultant polyarylate resin (R-7-M1) had a mass yield of 28.9 g, a percentage yield of 78.6%, and a viscosity average molecular weight of 47,600.

### (Synthesis of Polyarylate Resin (R-8-M1))

In synthesis of the polyarylate resin (R-8-M1), the compound (BP-1-1) was changed to 82.56 mmol of the compound (BP-1-4). The resultant polyarylate resin (R-8-M1) had a mass yield of 27.8 g, a percentage yield of 80.6%, and a viscosity average molecular weight of 55,100.

### (Synthesis of Polyarylate Resin (R-9-M1))

In synthesis of the polyarylate resin (R-9-M1), dichloride of the compound (DC-2-1C) was not used. Furthermore, in synthesis of the polyarylate resin (R-9-M1), the amount of dichloride of the compound (DC-2-2A) was changed to 77.8 mmol. The resultant polyarylate resin (R-9-M1) had a mass yield of 28.8 g, a percentage yield of 79.7%, and a viscosity average molecular weight of 60,000.

### (Synthesis of Polyarylate Resin (R-10-M1))

In synthesis of the polyarylate resin (R-10-M1), the compound (BP-1-1) was changed to 82.56 mmol of the compound (BP-1-2). Furthermore, in synthesis of the polyarylate resin (R-10-M1), the amount of dichloride of the compound (DC-2-1C) was changed to 54.5 mmol and the amount of dichloride of the compound (DC-2-2A) was changed to 23.3 mmol. The resultant polyarylate resin (R-10-M1) had a mass yield of 30.0 g, a percentage yield of 78.9%, and a viscosity average molecular weight of 49,700.

### (Synthesis of Polyarylate Resin (R-1-M2))

In synthesis of the polyarylate resin (R-1-M2), the compound (T-M1) was changed to 0.826 mmol of the compound (T-M2). The resultant polyarylate resin (R-1-M2) had a mass yield of 27.5 g, a percentage yield of 79.7%, and a viscosity average molecular weight of 53,500.

### (Synthesis of Polyarylate Resin (R-1-M3))

In synthesis of the polyarylate resin (R-1-M3), the compound (T-M1) was changed to 0.826 mmol of the compound (T-M3). The resultant polyarylate resin (R-1-M3) had a mass yield of 28.6 g, a percentage yield of 82.9%, and a viscosity average molecular weight of 56,100.

### (Synthesis of Polyarylate Resin (R-1-M4))

In synthesis of the polyarylate resin (R-1-M4), the compound (T-M1) was changed to 0.826 mmol of the compound (T-M4). The resultant polyarylate resin (R-1-M4) had a mass yield of 28.4 g, a percentage yield of 82.4%, and a viscosity average molecular weight of 54,200.

### (Synthesis of Polyarylate Resin (R-1-MA))

In synthesis of the polyarylate resin (R-1-MA), the compound (T-M1) was changed to 0.826 mmol of a compound represented by chemical formula (T-MA) shown below (p-tert-butylphenol). The resultant polyarylate resin (R-1-MA) had a mass yield of 29.0 g, a percentage yield of 84.1%, and a viscosity average molecular weight of 58,100.

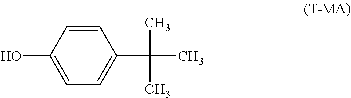

### <Photosensitive Member Production Method>

Photosensitive members of Examples 1 to 25 and Comparative Examples 1 to 15 were produced by the following methods.

### Example 1

An intermediate layer was formed on a conductive substrate by the following method. First, surface treated titanium oxide (“Test Sample SMT-A”, product of Tayca Corporation, average primary particle diameter 10 nm) was prepared. The test sample SMT-A was particles obtained in a manner that titanium oxide was surface treated with alumina and silica and was further surface treated with methyl hydrogen polysiloxane under wet dispersion of the titanium oxide surface treated with alumina and silica. The test sample SMT-A (2.0 parts by mass) and a polyamide resin (“AMILAN (registered Japanese trademark) CM8000”, product of Toray Industries, Inc., quaternary copolyamide resin of polyamide 6, polyamide 12, polyamide 66, and polyamide 610, 1.0 parts by mass) were added to a solvent containing methanol (10.0 parts by mass), butanol (1.0 parts by mass), and toluene (1.0 parts by mass). Next, mixing was performed for 5 hours using a bead mill in order to disperse these materials in the solvent. Through the above, an application liquid for intermediate layer formation was prepared. Next, the resultant application liquid for intermediate layer formation was filtered using a filter having a pore size of 5 μm. Thereafter, the filtered application liquid for intermediate layer formation was applied onto the surface of the conductive substrate by dip coating. The conductive substrate was a drum-shaped aluminum support (diameter: 30 mm, total length: 246 mm). Next, the applied application liquid for intermediate layer formation was dried for 30 minutes at a temperature of 130° C., thereby forming an intermediate layer (film thickness 1.5 μm) on the conductive substrate. Through the above process, a multi-layer body including the conductive substrate and the intermediate layer (also referred to below as a first multi-layer body) was obtained.

Next, a charge generating layer was formed on the intermediate layer of the first multi-layer body. Specifically, Y-form titanyl phthalocyanine (1.5 parts by mass) as a pigment, and a polyvinyl acetal resin (“S-LEC (registered Japanese trademark) BX-5”, product of Sekisui Chemical Co., Ltd., 1.0 parts by mass) as a base resin were added to a solvent containing propylene glycol monomethyl ether (40.0 parts by mass) and tetrahydrofuran (40.0 parts by mass). Mixing was performed for 12 hours using a bead mill in order to disperse these materials in the solvent. Through the above, an application liquid for charge generating layer formation was prepared. Next, the resultant application liquid for charge generating layer formation was filtered using a filter having a pore size of 3 μm. Next, the resultant filtrate was applied onto the intermediate layer of the first multi-layer body by dip coating and the applied filtrate was dried for 5 minutes at a temperature of 50° C. Through the above process, a charge generating layer (film thickness 0.15 μm) was formed on the intermediate layer. Thus, a multi-layer body including the conductive substrate, the intermediate layer formed on the conductive substrate, and the charge generating layer formed on the intermediate layer (also referred to below as a second multi-layer body) was obtained.

Next, a charge transport layer was formed on the charge generating layer of the second multi-layer body. Specifically, 50.0 parts by mass of the hole transport material (HTM-1), 3.0 parts by mass of meta-terphenyl as an additive, 2.0 parts by mass of 3,3′,5,5′-tetra-tert-butyl-4,4′-diphenoquinone as an electron acceptor compound, 100.0 parts by mass of the polyarylate resin (R-1-M1) as a binder resin, and 4.0 parts by mass of the filler particles (F1) were added to a solvent containing 550.0 parts by mass of tetrahydrofuran and 150.0 parts by mass of toluene. Mixing was performed for 12 hours using a circulation type ultrasonic disperser in order to disperse these materials in the solvent. Through the above, an application liquid for charge transport layer formation was prepared. The application liquid for charge transport layer formation was applied onto the charge generating layer of the second multi-layer body by dip coating. The second multi-layer body to which the application liquid for charge transport layer formation had been applied was put into an oven, and was dried for 40 minutes at a temperature of 120° C. using the oven. Through the above process, a charge transport layer (film thickness 30 μm) was formed on the charge generating layer. As a result, the photosensitive member of Example 1 was obtained. The photosensitive member of Example 1 included the conductive substrate, the intermediate layer formed on the conductive substrate, the charge generating layer formed on the intermediate layer, and the charge transport layer formed on the charge generating layer.

### Examples 2 to 25 and Comparative Examples 1 to 15

The photosensitive members of Examples 2 to 25 and Comparative Examples 1 to 15 were produced by the same method as that for the photosensitive member of Example 1 in all aspects other than the following changes. In production of the photosensitive members of Examples 2 to 25 and Comparative Examples 1 to 15, types of binder resins, types and amounts of filler particles, types and amount of additives, and thickness of charge generating layers were set as those in Tables 3 and 4 below.

TABLE 3

| | Charge transport layer | | | | | | | | | | | Charge |
|---|---|---|---|---|---|---|---|---|---|---|---|---|
| | | | | | | Filler particles | | | | | | generating |
| | Polyarylate resin | | | | | | | Particle | | Additive | | layer |
| | | Unit | Unit | Group | Ratio | | | diameter | Part by | | Part by | thickness |
| | Type | (1) | (2) | (3) | p | Type | Material | [μm] | mass | Type | mass | [μm] |
| Exam- | R-1-M1 | 1-1 | 2-1C/2-2A | M1 | 0.50 | F1 | PTFE | 3.5 | 4.0 | ADD1 | 3.0 | 0.15 |
| ple 1 | | | | | | | | | | | | |
| Exam- | R-1-M1 | 1-1 | 2-1C/2-2A | M1 | 0.50 | F1 | PTFE | 3.5 | 4.0 | ADD1 | 3.0 | 0.25 |
| ple 2 | | | | | | | | | | | | |
| Exam- | R-1-M1 | 1-1 | 2-1C/2-2A | M1 | 0.50 | F1 | PTFE | 3.5 | 4.0 | ADD1 | 3.0 | 0.35 |
| ple 3 | | | | | | | | | | | | |
| Exam- | R-1-M1 | 1-1 | 2-1C/2-2A | M1 | 0.50 | F2 | PTFE | 0.6 | 4.0 | ADD1 | 3.0 | 0.25 |
| ple 4 | | | | | | | | | | | | |
| Exam- | R-1-M1 | 1-1 | 2-1C/2-2A | M1 | 0.50 | F3 | PTFE | 3.0 | 4.0 | ADD1 | 3.0 | 0.25 |
| ple 5 | | | | | | | | | | | | |
| Exam- | R-1-M1 | 1-1 | 2-1C/2-2A | M1 | 0.50 | F4 | PTFE | 10.0 | 4.0 | ADD1 | 3.0 | 0.25 |
| ple 6 | | | | | | | | | | | | |
| Exam- | R-1-M1 | 1-1 | 2-1C/2-2A | M1 | 0.50 | F1 | PTFE | 3.5 | 2.0 | ADD1 | 3.0 | 0.25 |
| ple 7 | | | | | | | | | | | | |
| Exam- | R-1-M1 | 1-1 | 2-1C/2-2A | M1 | 0.50 | F1 | PTFE | 3.5 | 10.0 | ADD1 | 3.0 | 0.25 |
| ple 8 | | | | | | | | | | | | |
| Exam- | R-1-M1 | 1-1 | 2-1C/2-2A | M1 | 0.50 | — | — | — | — | ADD1 | 8.0 | 0.25 |
| ple 9 | | | | | | | | | | | | |
| Exam- | R-1-M1 | 1-1 | 2-1C/2-2A | M1 | 0.50 | — | — | — | — | ADD1 | 10.0 | 0.25 |
| ple 10 | | | | | | | | | | | | |
| Exam- | R-1-M1 | 1-1 | 2-1C/2-2A | M1 | 0.50 | — | — | — | — | ADD1 | 13.0 | 0.25 |
| ple 11 | | | | | | | | | | | | |
| Exam- | R-1-M1 | 1-1 | 2-1C/2-2A | M1 | 0.50 | F1 | PTFE | 3.5 | 4.0 | ADD1 | 10.0 | 0.15 |
| ple 12 | | | | | | | | | | | | |
| Exam- | R-1-M1 | 1-1 | 2-1C/2-2A | M1 | 0.50 | F1 | PTFE | 3.5 | 4.0 | ADD1 | 10.0 | 0.35 |
| ple 13 | | | | | | | | | | | | |
| Exam- | R-2-M1 | 1-1 | 2-1C/2-2B | M1 | 0.50 | F1 | PTFE | 3.5 | 4.0 | ADD1 | 3.0 | 0.25 |
| ple 14 | | | | | | | | | | | | |
| Exam- | R-3-M1 | 1-2 | 2-1C/2-2A | M1 | 0.50 | F1 | PTFE | 3.5 | 4.0 | ADD1 | 3.0 | 0.25 |
| ple 15 | | | | | | | | | | | | |
| Exam- | R-4-M1 | 1-2 | 2-1C/2-2A | M1 | 0.30 | F1 | PTFE | 3.5 | 4.0 | ADD1 | 3.0 | 0.25 |
| ple 16 | | | | | | | | | | | | |
| Exam- | R-5-M1 | 1-2/1-3 | 2-1C/2-2A | M1 | 0.10 | F1 | PTFE | 3.5 | 4.0 | ADD1 | 3.0 | 0.25 |
| ple 17 | | | | | | | | | | | | |
| Exam- | R-6-M1 | 1-2 | 2-1C/2-2B | M1 | 0.50 | F1 | PTFE | 3.5 | 4.0 | ADD1 | 3.0 | 0.25 |
| ple 18 | | | | | | | | | | | | |
| Exam- | R-7-M1 | 1-2 | 2-1C/2-2D | M1 | 0.50 | F1 | PTFE | 3.5 | 4.0 | ADD1 | 3.0 | 0.25 |
| ple 19 | | | | | | | | | | | | |
| Exam- | R-8-M1 | 1-4 | 2-1C/2-2A | M1 | 0.50 | F1 | PTFE | 3.5 | 4.0 | ADD1 | 3.0 | 0.25 |
| ple 20 | | | | | | | | | | | | |

TABLE 4

| | Charge transport layer | | | | | | | | | | | Charge |
|---|---|---|---|---|---|---|---|---|---|---|---|---|
| | | | | | | Filler particles | | | | | | generating |
| | Polyarylate resin | | | | | | | Particle | | Additive | | layer |
| | | Unit | Unit | Group | Ratio | | | diameter | Part by | | Part by | thickness |
| | Type | (1) | (2) | (3) | p | Type | Material | [μm] | mass | Type | mass | [μm] |
| Example 21 | R-9-M1 | 1-1 | 2-2A | M1 | — | F1 | PTFE | 3.5 | 4.0 | ADD1 | 3.0 | 0.25 |
| Example 22 | R-10-M1 | 1-2 | 2-1C/2-2A | M1 | 0.70 | F1 | PTFE | 3.5 | 4.0 | ADD1 | 3.0 | 0.25 |
| Example 23 | R-1-M2 | 1-1 | 2-1C/2-2A | M2 | 0.50 | F1 | PTFE | 3.5 | 4.0 | ADD1 | 3.0 | 0.25 |
| Example 24 | R-1-M3 | 1-1 | 2-1C/2-2A | M3 | 0.50 | F1 | PTFE | 3.5 | 4.0 | ADD1 | 3.0 | 0.25 |
| Example 25 | R-1-M4 | 1-1 | 2-1C/2-2A | M4 | 0.50 | F1 | PTFE | 3.5 | 4.0 | ADD1 | 3.0 | 0.25 |
| Comparative | R-1-M1 | 1-1 | 2-1C/2-2A | M1 | 0.50 | — | — | — | — | ADD1 | 3.0 | 0.25 |
| Example 1 | | | | | | | | | | | | |
| Comparative | R-1-M1 | 1-1 | 2-1C/2-2A | M1 | 0.50 | — | — | — | — | ADD1 | 20.0 | 0.25 |
| Example 2 | | | | | | | | | | | | |
| Comparative | R-1-M1 | 1-1 | 2-1C/2-2A | M1 | 0.50 | — | — | — | — | ADD1 | 25.0 | 0.25 |
| Example 3 | | | | | | | | | | | | |
| Comparative | R-1-M1 | 1-1 | 2-1C/2-2A | M1 | 0.50 | F1 | PTFE | 3.5 | 1.0 | ADD1 | 3.0 | 0.10 |
| Example 4 | | | | | | | | | | | | |
| Comparative | R-1-M1 | 1-1 | 2-1C/2-2A | M1 | 0.50 | F1 | PTFE | 3.5 | 12.0 | ADD1 | 3.0 | 0.10 |
| Example 5 | | | | | | | | | | | | |
| Comparative | R-1-M1 | 1-1 | 2-1C/2-2A | M1 | 0.50 | F1 | PTFE | 3.5 | 4.0 | ADD1 | 3.0 | 0.10 |
| Example 6 | | | | | | | | | | | | |
| Comparative | R-1-M1 | 1-1 | 2-1C/2-2A | M1 | 0.50 | — | — | — | — | ADD1 | 10.0 | 0.10 |
| Example 7 | | | | | | | | | | | | |
| Comparative | R-1-M1 | 1-1 | 2-1C/2-2A | M1 | 0.50 | F5 | Silica | 0.007 | 4.0 | ADD1 | 3.0 | 0.10 |
| Example 8 | | | | | | | | | | | | |
| Comparative | R-1-M1 | 1-1 | 2-1C/2-2A | M1 | 0.50 | F6 | Silicone | 0.6 | 4.0 | ADD1 | 3.0 | 0.10 |
| Example 9 | | | | | | | | | | | | |
| Comparative | R-1-M1 | 1-1 | 2-1C/2-2A | M1 | 0.50 | F7 | Silicone | 0.7 | 4.0 | ADD1 | 3.0 | 0.10 |
| Example 10 | | | | | | | | | | | | |
| Comparative | R-1-M1 | 1-1 | 2-1C/2-2A | M1 | 0.50 | Fl | PTFE | 3.5 | 4.0 | ADD1 | 10.0 | 0.05 |
| Example 11 | | | | | | | | | | | | |
| Comparative | R-1-MA | 1-1 | 2-1C/2-2A | MA | 0.50 | F1 | PTFE | 3.5 | 4.0 | ADD1 | 3.0 | 0.25 |
| Example 12 | | | | | | | | | | | | |
| Comparative | R-1-M1 | 1-1 | 2-1C/2-2A | M1 | 0.50 | — | — | — | — | ADD2 | 10.0 | 0.25 |
| Example 13 | | | | | | | | | | | | |
| Comparative | R-1-M1 | 1-1 | 2-1C/2-2A | M1 | 0.50 | — | — | — | — | ADD3 | 10.0 | 0.25 |
| Example 14 | | | | | | | | | | | | |
| Comparative | R-1-M1 | 1-1 | 2-1C/2-2A | M1 | 0.50 | — | — | — | — | ADD4 | 10.0 | 0.25 |
| Example 15 | | | | | | | | | | | | |

The photosensitive members of Examples 1 to 8 and 14 to 25 and Comparative Example 12 each satisfied conditions (A) and (B). The photosensitive members of Examples 9 to 11 each satisfied conditions (A) and (C). The photosensitive members of Examples 12 to 13 each satisfied conditions (B) and (C). The photosensitive members of Comparative Examples 1 to 3 and 13 to 15 each satisfied condition (A). The photosensitive members of Comparative Examples 4, 5, and 8 to 10 each satisfied none of the conditions (A) to (C). The photosensitive member of Comparative Example 6 satisfied condition (B). The photosensitive member of Comparative Example 7 satisfied condition (C). The photosensitive member of Comparative Example 11 satisfied conditions (B) and (C).

### <Measurement and Evaluation>

With respect to each of the photosensitive members of Examples 1 to 25 and Comparative Examples 1 to 15, sensitivity variation depending on humidity was measured and sensitivity, abrasion resistance, and band generation caused due to high humidity were evaluated. The obtained results are shown in Tables 5 and 6 below.

### [Sensitivity Variation Depending on Humidity]

Sensitivity of each of the photosensitive members was measured in a normal-temperature and high-humidity environment at a temperature of 23° C. and a relative humidity of 90%. First, the surface of the photosensitive member was charged to −550 V using a drum sensitivity test device (product of Gen-Tech, Inc.). Next, monochromatic light (wavelength: 780 nm, exposure amount: 0.18 μJ/cm²) was taken out from light of a halogen lamp using a bandpass filter and irradiation using the taken monochromatic light was performed on the surface of the photosensitive member. A surface potential (post-exposure potential (VNH) [V] in the normal-temperature and high-humidity environment) of the photosensitive member was measured at a time when 50 milliseconds elapsed from termination of the monochromatic light irradiation.

A post-exposure potential (VNL) [V] in a normal-temperature and low-humidity environment was measured by the same method as the method for measuring the post-exposure potential VNH in all aspects other than that the measurement environment was changed to a normal-temperature and low-humidity environment at a temperature of 23° C. and a relative humidity of 10%. A sensitivity variation [V] depending on humidity was calculated using the following equation. A smaller sensitivity variation [V] depending on humidity indicates lower susceptibility of sensitivity of a photosensitive member to humidity.

Sensitivity variation depending on humidity [V]=|V_{NH}[V]−V_{NL}[V]|

### [Abrasion Resistance]

A color printer (“C711dn”, product of Oki Data Corporation) was used as an evaluation apparatus. A cyan toner was loaded into a toner cartridge of the evaluation apparatus. First, with respect to each of the photosensitive member, a film thickness Ti of the charge transport layer of the photosensitive member was measured. Next, the photosensitive member was mounted in the evaluation apparatus. Subsequently, an image I (pattern image having a printing rate of 1%) was printed on 10,000 sheets of paper using the evaluation apparatus in a normal-temperature and normal-humidity environment (temperature 23° C., relative humidity 50%). Subsequently, the mage I was printed on 10,000 sheets of paper using the evaluation apparatus in a high-temperature and high-humidity environment (temperature 32° C., relative humidity 85%). The mage I was then printed on 10,000 sheets of paper using the evaluation apparatus in a low-temperature and low-humidity environment (temperature 10° C., relative humidity 15%: also referred to below as an LL environment). After the printing in the LL environment, the evaluation apparatus was left to stand for 2 hours. Next, a solid image (image having an image density of 100%) was printed on one sheet of paper in the LL environment. Thereafter, a film thickness T₂ of the charge transport layer of the photosensitive member was measured. An abrasion amount (T₁-T₂ [μm]) was obtained which is an amount of film thickness variation of the charge transport layer between before and after the printing. The obtained abrasion amounts are shown in Tables 5 and 6 below. A smaller abrasion amount indicates more excellent abrasion resistance of a photosensitive member. An evaluation amount of no greater than 2.5 μm can be evaluated as a photosensitive member having excellent abrasion resistance and an abrasion amount of greater than 2.5 μm can be evaluated as a photosensitive member having poor abrasion resistance.

### [Sensitivity]

Sensitivity of each of the photosensitive members was measured in an environment at a temperature of 23° C. and a relative humidity of 50%. Specifically, the surface of the photosensitive member was charged to −550 V using a drum sensitivity test device (product of Gen-Tech, Inc.). Next, monochromatic light (wavelength: 780 nm, exposure amount: 1.0 μJ/cm²) was taken out from light of a halogen lamp using a bandpass filter and irradiation using the taken monochromatic light was performed on the surface of the photosensitive member. A surface potential (post-exposure potential [V]) of the photosensitive member was measured at a time when 50 milliseconds elapsed from termination of the monochromatic light irradiation. A sensitivity of 85 V or lower in terms of an absolute value can be evaluated as acceptable, and a sensitivity of over 85 V in terms of an absolute value can be evaluated as rejected.

### [Band Generation Caused Due to High Humidity]

A monochrome multifunction peripheral (“MultiXpress SL-K4350LX”, product of Samsung Electronics Co., Ltd.) was used as an evaluation apparatus. With respect to each of the photosensitive members, the photosensitive member was mounted in the evaluation apparatus first. In doing so, a piece of wet paper (a piece of absorbent paper having a basis weight 80 g/m² in which 20% by mass of pure water had been impregnated) was interposed between the photosensitive member and a charging roller of the evaluation apparatus. Next, the evaluation apparatus was left to stand for one day in a normal-temperature and normal-humidity environment (temperature 23° C., relative humidity 50%), and then, the piece of wet paper was removed. Thereafter, a halftone image (printing rate 30%) was printed on one sheet of printing paper using the evaluation apparatus in the normal-temperature and normal-humidity environment and the resultant image was used as an evaluation image. The evaluation image was visually observed to determine a degree of a black line (band generated due to high humidity) in accordance with the following determination criteria. The photosensitive member can be evaluated as being capable of inhibiting band generation caused due to high humidity when a result of determination for a black stripe was rated as “A” or “B” and as being incapable of inhibiting band generation caused due to high humidity when a result of determination for a black stripe was rated as “C”.

### (Evaluation Criteria)

A: No black stripes were observed on the evaluation image.

B: A faint black stripe was observed on the evaluation image, which involved no problems in practical use.

C: A clearly perceivable black stripe was observed on the evaluation image.

TABLE 5

| | Sensitivity variation | | Abrasion | |
|---|---|---|---|---|
| | depending on humidity | Sensitivity | amount | Band |
| | [V] | [V] | [μm] | generation |
| Example 1 | 21 | −80 | 1.0 | A |
| Example 2 | 20 | −77 | 1.0 | A |
| Example 3 | 18 | −74 | 1.0 | A |
| Example 4 | 18 | −78 | 1.2 | A |
| Example 5 | 20 | −77 | 0.8 | A |
| Example 6 | 22 | −81 | 0.6 | B |
| Example 7 | 22 | −84 | 1.2 | B |
| Example 8 | 18 | −75 | 0.7 | A |
| Example 9 | 21 | −78 | 1.3 | A |
| Example 10 | 20 | −80 | 1.3 | A |
| Example 11 | 18 | −81 | 1.4 | A |
| Example 12 | 19 | −85 | 1.1 | A |
| Example 13 | 15 | −77 | 1.1 | A |
| Example 14 | 20 | −76 | 1.0 | A |
| Example 15 | 20 | −75 | 1.1 | A |
| Example 16 | 19 | −73 | 1.1 | A |
| Example 17 | 20 | −76 | 1.2 | A |
| Example 18 | 20 | −74 | 1.2 | A |
| Example 19 | 20 | −76 | 1.2 | A |
| Example 20 | 20 | −76 | 1.4 | A |
| Example 21 | 20 | −74 | 1.4 | A |
| Example 22 | 21 | −78 | 0.8 | A |
| Example 23 | 18 | −73 | 1.0 | A |
| Example 24 | 18 | −73 | 0.9 | A |
| Example 25 | 20 | −77 | 1.1 | A |

TABLE 6

| | Sensitivity variation | | Abrasion | |
|---|---|---|---|---|
| | depending on humidity | Sensitivity | amount | Band |
| | [V] | [V] | [μm] | generation |
| Comparative | 30 | −95 | 1.7 | C |
| Example 1 | | | | |
| Comparative | 18 | −90 | 1.6 | A |
| Example 2 | | | | |
| Comparative | 19 | −93 | 1.6 | A |
| Example 3 | | | | |
| Comparative | 26 | −86 | 1.6 | C |
| Example 4 | | | | |
| Comparative | 24 | −95 | 0.8 | B |
| Example 5 | | | | |
| Comparative | 31 | −86 | 1.0 | C |
| Example 6 | | | | |
| Comparative | 28 | −87 | 1.8 | C |
| Example 7 | | | | |
| Comparative | 27 | −80 | 1.4 | C |
| Example 8 | | | | |
| Comparative | 29 | −81 | 1.8 | C |
| Example 9 | | | | |
| Comparative | 31 | −79 | 1.7 | C |
| Example 10 | | | | |
| Comparative | 23 | −93 | 1.1 | B |
| Example 11 | | | | |
| Comparative | 20 | −79 | 2.8 | A |
| Example 12 | | | | |
| Comparative | 27 | −81 | 1.4 | C |
| Example 13 | | | | |
| Comparative | 30 | −88 | 1.5 | C |
| Example 14 | | | | |
| Comparative | 25 | −96 | 1.4 | B |
| Example 15 | | | | |

Each of the photosensitive members of Examples 1 to 25 included a conductive substrate and a photosensitive member disposed either directly or indirectly on the conductive substrate. The photosensitive layer included a charge generating layer and a charge transport layer disposed in stated order from a side of the conductive substrate. The charge generating layer had a thickness of at least 0.07 μm. The charge transport layer contained a binder resin, a hole transport material, and meta-terphenyl. The binder resin included the polyarylate resin (PA) including the repeating unit (1), the repeating unit (2), and the terminal group (3). Each of the photosensitive members of Examples 1 to 25 satisfied at least two of the following conditions (A) to (C). Thus, the photosensitive members of Examples 1 to 25 were excellent in sensitivity and abrasion resistance and can inhibit band generation caused due to high humidity as evident from Table 5.

(A) The charge generating layer has a thickness of at least 0.12 μm.
(B) The charge transport layer contains fluororesin particles in an amount of at least 1.5 parts by mass and no greater than 11.0 parts by mass relative to 100 parts by mass of the binder resin.
(C) The charge transport layer contains meta-terphenyl in an amount of at least 5.0 parts by mass and no greater than 15.0 parts by mass relative to 100 parts by mass of the binder resin.

By contrast, each of the photosensitive members of Comparative Examples 1 to 15 did not have the above structure. Therefore, each of the photosensitive members of Comparative Examples 1 to 15 was poor in at least one of sensitivity characteristics, abrasion resistance, and inhibition of band generation caused due to high humidity.

What is claimed is:

1. An electrophotographic photosensitive member comprising a conductive substrate and a photosensitive layer disposed either directly or indirectly on the conductive substrate, wherein
the photosensitive layer includes a charge generating layer and a charge transport layer disposed in stated order from a side of the conductive substrate,
the charge generating layer has a thickness of at least 0.07 μm,
the charge transport layer contains a binder resin, a hole transport material, and meta-terphenyl,
the binder resin includes a polyarylate resin including a first repeating unit represented by general formula (1) shown below, a second repeating unit represented by general formula (2) shown below, and a terminal group represented by general formula (3) shown below, and
at least two conditions of the following conditions (A) to (C) are satisfied:
(A) the charge generating layer has a thickness of at least 0.12 μm;
(B) the charge transport layer contains fluororesin particles in an amount of at least 1.5 parts by mass and no greater than 11.0 parts by mass relative to 100 parts by mass of the binder resin; and
(C) the charge transport layer contains the meta-terphenyl in an amount of at least 5.0 parts by mass and no greater than 15.0 parts by mass relative to 100 parts by mass of the binder resin, 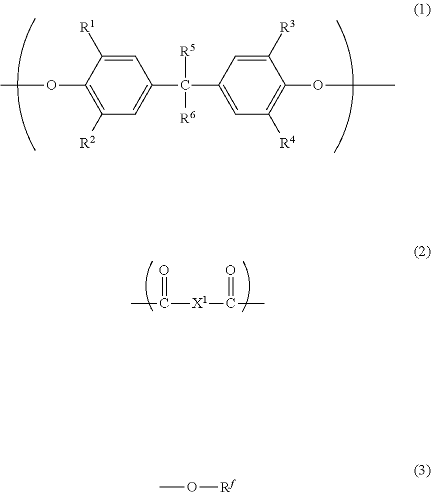
where in the general formula (1),
R¹, R², R³, and R⁴ each represent, independently of one another, a hydrogen atom or a methyl group,
R⁵ and R⁶ each represent, independently of one another, a hydrogen atom or an alkyl group having a carbon number of at least 1 and no greater than 4, and
R⁵ and R⁶ may be bonded to each other to form a divalent group represented by general formula (X) shown below,
in the general formula (2), X¹ represents a divalent group represented by chemical formula (2A), (2B), (2C), or (2D) shown below, and
in the general formula (3), R^{f} represents a chain aliphatic group having a carbon number of at least 1 and no greater than 20 and substituted with at least one fluorine atom, 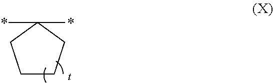
where in the general formula (X),
t represents an integer of no less than 1 and no greater than 3, and
* represents a bond,

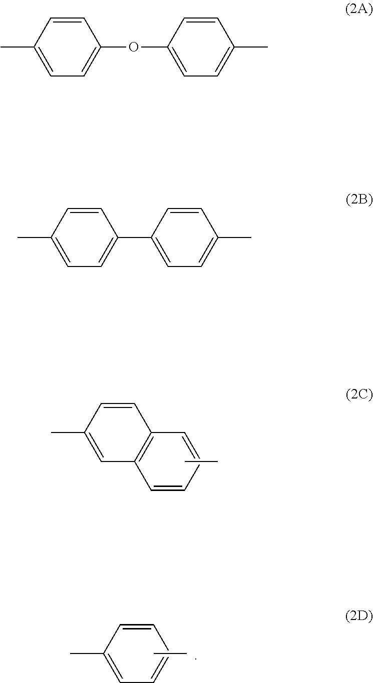

2. The electrophotographic photosensitive member according to claim 1, wherein
the fluororesin particles are polytetrafluoroethylene particles.

3. The electrophotographic photosensitive member according to claim 1, wherein
the first repeating unit is represented by chemical formula (1-1), (1-2), (1-3), or (1-4) shown below:

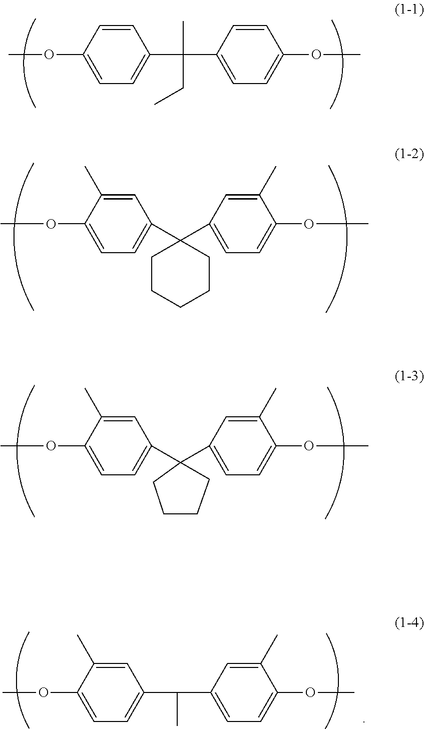

4. The electrophotographic photosensitive member according to claim 1, wherein
the second repeating unit is represented by chemical formula (2-1C), (2-2A), (2-2B), or (2-2D) shown below:

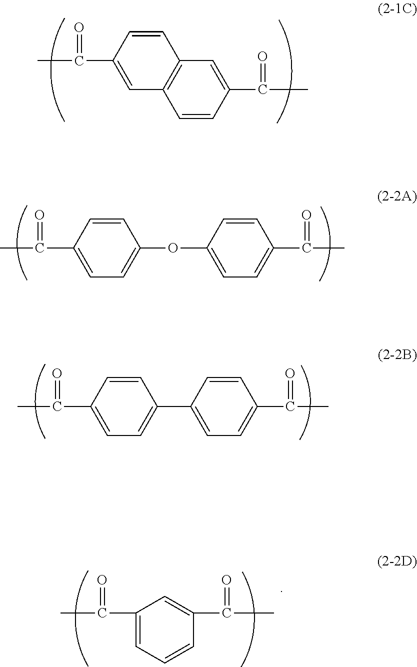

5. The electrophotographic photosensitive member according to claim 1, wherein
the terminal group is represented by chemical formula (M1), (M2), (M3), or (M4) shown below:

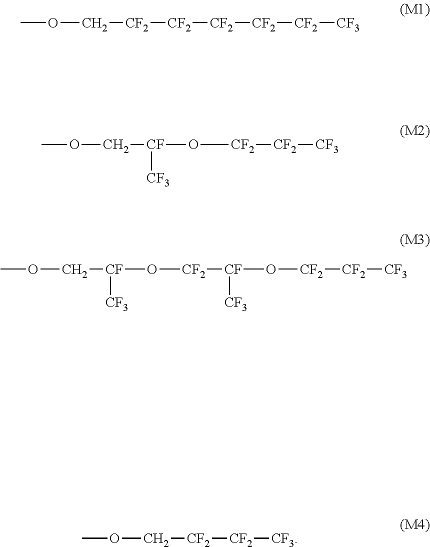

6. The electrophotographic photosensitive member according to claim 1, wherein
the hole transport material contains a compound represented by general formula (10) shown below: 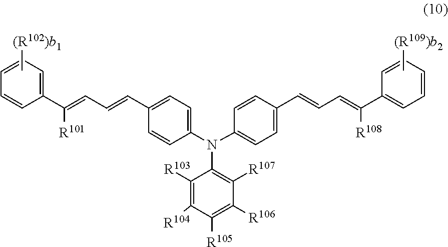
where in the general formula (10),
R¹⁰¹, R¹⁰³, R¹⁰⁴, R¹⁰⁵, R¹⁰⁶ R¹⁰⁷, and R¹⁰⁸ each represent, independently of one another, a hydrogen atom, an alkyl group having a carbon number of at least 1 and no greater than 8, a phenyl group optionally substituted with an alkyl group having a carbon number of at least 1 and no greater than 8, or an alkoxy group having a carbon number of at least 1 and no greater than 8,
two adjacent groups among R¹⁰³, R¹⁰⁴, R¹⁰⁵, R¹⁰⁶, and R¹⁰⁷ may be bonded to each other to form a cycloalkane having a carbon number of at least 5 and no greater than 7,
R¹⁰² and R¹⁰⁹ each represent, independently of one another, a phenyl group, an alkyl group having a carbon number of at least 1 and no greater than 8, or an alkoxy group having a carbon number of at least 1 and no greater than 8, and
b₁ and b₂ each represent, independently of one another, an integer of at least 0 and no greater than 5.

7. The electrophotographic photosensitive member according to claim 6, wherein
the hole transport material contains a compound represented by general formula (HTM-1) shown below:

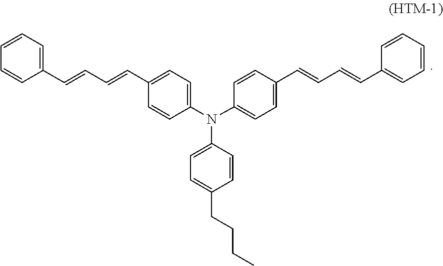

8. The electrophotographic photosensitive member according to claim 1, wherein
the charge transport layer contains an electron acceptor compound represented by general formula (E-1) shown below: 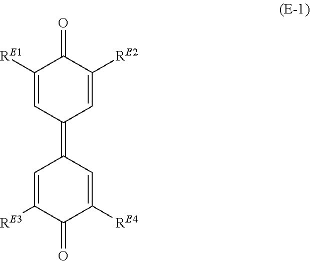
where in the general formula (E-1), R^{E1}, R^{E2}, R^{E3}, and R^{E4} each represent, independently of one another, an alkyl group having a carbon number of at least 1 and no greater than 6.

9. The electrophotographic photosensitive member according to claim 8, wherein
the electron acceptor compound includes a compound represented by chemical formula (ET1) shown below: 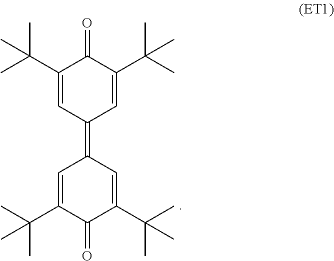 [SMILES: CC(C)(C)C1=CC(=C2C=C(C(C)(C)C)C(=O)C(C(C)(C)C)=C2)C=C(C(C)(C)C)C1=O]
